(19) United States
(12) Patent Application Publication
(10) Pub. No.: US 2023/0001386 A1
(43) Pub. Date: Jan. 5, 2023

(54) THERMAL AGING RESILIENT OXIDATION CATALYSTS FOR DIESEL EMISSION CONTROL

(71) Applicant: BASF Corporation, Florham Park, NJ (US)

(72) Inventors: M Shahjahan KAZI, Iselin, NJ (US); Andreas R. MUNDING, Huntsville, AL (US); David M. YOUNGREN, Union, NJ (US)

(21) Appl. No.: 17/756,482

(22) PCT Filed: Nov. 26, 2020
(86) PCT No.: PCT/US2020/062454

§ 371 Date: May 26, 2022

Related U.S. Application Data
(60) Provisional application No. 62/941,184, filed on Nov. 27, 2019.

(51) Int. Cl. B01J 23/42; B01J 21/06; B01J 21/08; B01J 35/00; B01J 35/04; B01J 37/02; B01D 53/94; F01N 3/28

(52) U.S. Cl. CPC B01J 23/42; B01J 21/063; B01J 21/08; B01J 35/0013; B01J 35/04; B01J 35/0046; B01J 37/0215; B01D 53/944; B01D 53/9477; F01N 3/2803; B01D 2255/9202; B01D 2255/1021; B01D 2255/9155; F01N 2370/02

(57) ABSTRACT

An oxidation catalyst composition is provided, the composition including a plurality of platinum group metal particles having a multi-modal distribution of particle sizes. The plurality of platinum group metal particles includes a first population of platinum group metal particles having a range of particle sizes of from about 0.5 nm to about 3 nm, and a second population of platinum group metal particles having a range of particle sizes of from about 4 nm to about 15 nm. Methods for the preparation and use of the catalyst composition are also provided, as well as catalyst articles and emission gas treatment systems employing such catalyst articles. The catalyst exhibits enhanced stability with respect to oxidation performance after degreening and/or aging, as compared to conventional oxidation catalysts, in particular less loss of NOx oxidation performance.

The present disclosure relates generally to the field of exhaust gas treatment catalysts, particularly oxidation catalyst compositions comprising platinum group metal particles, methods for the preparation and use of such catalyst compositions, and catalyst articles and exhaust gas treatment systems employing such catalyst compositions.

Environmental regulations for emissions of internal combustion engines are becoming increasingly stringent throughout the world. Operations of lean burn engines, for example diesel engines, provide the user with excellent fuel economy due to their operation at high air/fuel ratios under fuel lean conditions. However, diesel engines also emit exhaust gas emissions containing particulate matter, unburned hydrocarbons, carbon monoxide (CO), and nitrogen oxides (NOₓ), wherein NOₓ describes various chemical species of nitrogen oxides, including nitric oxide (NO) and nitrogen dioxide (NO₂), among others. The two major components of exhaust particulate matter are the soluble organic fraction and the soot fraction. The soluble organic fraction condenses on the soot in layers and is generally derived, from unburned diesel fuel and lubricating oils. The soluble organic fraction can exist in diesel exhaust either as a vapor or as an aerosol (i.e., fine droplets of liquid condensate), depending on the temperature of the exhaust gas. Soot is predominately composed of panicles of carbon.

Oxidation catalysts comprising precious metals, such as platinum group metals dispersed on a refractory metal oxide support, are known for use in treating the exhaust of diesel engines in order to convert both hydrocarbon and CO gaseous pollutants by catalyzing the oxidation of these pollutants to carbon dioxide (CO₂) and water. Such catalysts may be contained in diesel oxidation catalysts, which are placed in the exhaust flow path from a diesel-powered engine to treat the exhaust gas stream. Typically, the diesel oxidation catalysts are prepared on ceramic or metallic carrier substrates upon which one or more catalyst coating compositions are deposited.

Diesel soot removal is achieved via either active or passive regeneration of a soot filter. Active regeneration may be carried out by injecting additional diesel fuel at the diesel oxidation catalysts' inlet, and the exotherm released by the fuel combustion significantly raises the temperature at a downstream catalyzed soot filter and initiates soot combustion by O₂ according to the equation (C+O₂→CO/CO₂). This reaction typically temperatures in excess of 600° C. Passive soot regeneration utilizes NO₂ rather than O₂ to oxidize soot according to the equation C+NO₂CO/CO₂+NO). This reaction is efficient at temperatures greater than 300° C. and can often be accomplished during normal driving without requiring fuel injection, which results in a fuel economy penalty.

In addition to the conversion of gaseous hydrocarbons, CO and the soluble organic fraction of particulate matter, oxidation catalysts that contain platinum promote the oxidation of NO to NO₂. Platinum (Pt) remains the most effective platinum group metal for oxidizing NO to NO₂. Platinum group metals can be incorporated in diesel oxidation catalyst compositions in various forms. For example, certain catalyst compositions incorporate platinum group metals in the form of particles (e.g., nanoparticles). See Paulus et al., J. Electroanal, Chem., 134, 495 (2001); Yoo et al., J. Catalysis, 214, 1-7 (2003); and Jain et al., Acc. Chem. Res., 41, 1578-1586 (2008). For example, Pt nanoparticles with controlled size and shape provide great opportunities for developing high-performance industrial Pt catalysts. See Zhao et al., Adv. Mater., 11, 217-220 (1999); Oishi et al., React, Funct. Polym. 67, 662-668 (2007); and Peng et al., Nano Lett., 9, 3704-3709 (2009). Where platinum group metals are incorporated within a catalyst composition in the form of particles (e.g., nanoparticles), particle growth at elevated temperature (i.e., sintering), leading to a decrease in surface area, is a primary deactivation route for the catalyst composition. Particularly, NO oxidation has been widely reported to be structure-sensitive on Pt; i.e., turn-over frequency (TOF) is strongly dependent on the Pt particle size (Weiss et al., J. Phys. Chem. C, 2009, 30, 13331-13340). In addition, a fully reduced metallic Pt)(Pt⁰ surface is most active for NO oxidation.

The phenomenon of particle sintering, e.g., within platinum group metal-containing catalyst compositions, is believed to proceed by one of two limiting mechanisms, namely, Ostwald ripening or particle migration and coalescence. See, e.g., Hansen et al., Acc. Chem. Res, 2013, 46(8): 1720-30, the disclosure of which is incorporated herein by reference. Under the Ostwald ripening mechanism, it is assumed that metal particles are immobile and sintering occurs solely due to the migration of atoms or clusters from small particles to large particles. Under the particle migration and coalescence sintering mechanism, particles are understood to be mobile in a Brownian-like motion on the support surface, with subsequent coalescence leading to particle growth. By either or both mechanisms, significant (often up to 50%) loss of NO oxidation activity may be observed upon aging of conventional Pt-based diesel oxidation catalysts.

While addition of palladium (Pd) to Pt-based diesel oxidation catalysts may inhibit sintering of Pt and improve CO and hydrocarbon oxidation performance after high temperature aging, a high Pd concentration may decrease the activity of Pt to convert hydrocarbons and/or oxidize NO, especially when used with hydrocarbon storage materials, and may also make the catalyst more susceptible to sulfur poisoning. Accordingly, it would be advantageous to provide a catalyst composition comprising Pt that is not as susceptible to surface area loss to allow for continued high catalytic efficiency under high temperature conditions of use. Further, there is a continuing need to provide catalytic compositions that utilize metals (e.g., platinum group metals) efficiently and that remain effective to meet regulations for hydrocarbons, NOR, and CO conversion for long periods of time, particularly wider high temperature conditions.

Disclosed herein are catalyst compositions, catalyst articles, and catalyst systems comprising such catalyst articles. In some embodiments, catalyst compositions, catalyst articles, and catalyst systems comprising such catalyst articles exhibit enhanced aging stability with respect to oxidation performance. In some embodiments, an oxidation catalyst composition comprising a plurality of platinum group metal particles having a multi-modal distribution of particle sizes in which the plurality of platinum group metal particles are of two distinct and well-defined particle size ranges exhibit less loss of NOₓ oxidation performance after degreening and/or aging as compared to oxidation catalyst compositions which do not include such a multi-modal distribution of platinum group metal particles.

Accordingly, in one aspect an oxidation catalyst composition comprises a plurality of platinum group metal particles having a multi-modal distribution of particle sizes, wherein the plurality of platinum group metal particles comprises a first population of platinum group metal particles having a range of particle sizes of from about 0.5 nm to about 3 nm, and a second population of platinum group metal particles having a range of particle sizes of from about 4 nm to about 15 nm.

In some embodiments, the first population of platinum group metal particles has a particle size distribution characterized by an average particle size of about 1 nm and at least about 80% of the first population of platinum group metal particles have a particle size within about 1 nm of the average particle size.

10011.1 In some embodiments, the second population of platinum group metal particles has a particle size distribution characterized by an average particle size of about 6 nm and at least about 80% of the second population of platinum group metal particles have a particle size within about 2 nm of the average particle size.

In some embodiments, the ratio by weight of the first population of platinum group metal particles to the second population of platinum group metal particles is from about 10:90 to about 90:10. In some embodiments, the ratio by weight of the first population of platinum group metal particles to the second population of platinum group metal particles is from about 50:50 to about 90:10. In some embodiments, the ratio by weight of the first population of platinum group metal particles to the second population of platinum group metal particles is from about 50:50 to about 75:25.

In some embodiments, the plurality of platinum group metal particles has an average particle size of from about 3 nm to about 12 nm. In some embodiments, the plurality of platinum group metal particles has an average particle size of from about 3 nm to about 10 nm. In some embodiments, the plurality of platinum group metal particles has an average particle size of from about 3 to about 8 nm. In some embodiments, the plurality of platinum group metal particles has an average particle size of from about 3 to about 6 nm. In some embodiments, the plurality of platinum group metal particles has an average particle size of from about 3 to about 5 nm.

In some embodiments, at least about 90% of the platinum group metal is in a fully reduced firm.

In some embodiments, the platinum group metal comprises platinum, palladium, ruthenium, rhodium, iridium, or combinations thereof. In some embodiments, the platinum group metal comprises platinum, palladium, or combinations thereof. In some embodiments, the platinum group metal is platinum.

In some embodiments, the oxidation catalyst composition further comprises at least one refractory metal oxide support. In some embodiments, the at least one refractory metal oxide support comprises alumina (Al₂O₃), silica (SiO₂), zirconia (ZrO₂), titania (TiO₂), cerin (CeO₂), or combinations thereof. Combinations may be in the form of physical mixtures or chemical mixtures. In some embodiments, the at least one refractory metal oxide support comprises SiO₂-doped Al₂O₃, SiO₂-doped TiO₂, and/or SiO₂-doped ZrO₂. In some embodiments, the at least one refractory metal oxide support comprises Al₂O₃ doped with 1-10% SiO₂, TiO₂ doped with 1-20% SiO₂, axed/or ZrO₂ doped with 1-30% SiO₂.

In some embodiments, the first population of platinum group metal particles and the second population of platinum group metal particles are both dispersed on the same refractory metal oxide support. In some embodiments, the first population of platinum group metal particles and the second population of platinum group metal particles are each dispersed on separate refractory metal oxide supports, wherein the first population of platinum group metal particles is dispersed on a first refractory metal oxide support, and the second population of platinum group metal particles is dispersed on a second refractory metal oxide support, wherein the first refractory metal oxide support and the second refractory metal oxide support are each independently selected. In some embodiments, the first refractory metal oxide support and the second refractory metal oxide support both comprise the same refractory metal oxide support material. In some embodiments, the refractory metal oxide support material comprises TiO₂ or SiO₂-doped TiO₂.

In another aspect, an oxidation catalyst article comprises a substrate having an inlet end and an outlet end defining an overall length, and a catalytic coating comprising one or more washcoats disposed thereon, wherein at least one of the washcoats comprises the oxidation catalyst composition as disclosed herein.

In some embodiments, the substrate is a flow-through monolith or a wall-flow fitter.

In some embodiments, the oxidation catalyst article is a diesel oxidation catalyst article. In some embodiments, the plurality of platinum group metal particles is disposed on the substrate at a loading of from about 5 g/ft³ to about 200 g/ft³.

In some embodiments, the oxidation catalyst article is a catalyzed soot filter article. In some embodiments, the plurality of platinum group metal particles is disposed on the substrate at a loading of from about 0.5 g/ft³ to about 30 g/ft³.

In some embodiments, the oxidation catalyst article, after aging at 650° C. for 5 hours, exhibits a NO₂/NOₓ ratio of from about 40% to about 55% when disposed on a 1″×3″ flow-through substrate at a platinum group metal loading of 1.7 g/ft³ and subjected to a feed gas containing 600 ppm of NO, 10% 02, 5% CO₂, 5% H₂O, and 33 ppm propane at a temperature of 350° C. and space velocity of 50,000 per hour.

In some embodiments, the oxidation catalyst article, after degreening at 550° C., for 5 hours, has a first NO₂/NOₓ ratio, and, after aging at 650° C. for 5 hours, has a second NO₂/NOₓ ratio; wherein the second NO₂/NOₓ ratio is at least about 80% of the first NO₂/NOₓ ratio, when the oxidation catalyst article is disposed on a 1″×3″ flow-through substrate at a platinum group metal loading of 1.7 g/ft⁻³ and subjected to a feed gas containing 600 ppm of NO, 10% O₂, 5% CO₂, 5% H₂O, and 33 ppm propane at a temperature of 350° C. and space velocity of 50,000 per hour.

In another aspect, an exhaust gas treatment system comprises the oxidation catalyst article as disclosed herein, wherein the oxidation catalyst article is downstream of and in fluid communication with an internal combustion engine. In some embodiments, the exhaust gas treatment system further comprising one or more catalytic articles selected from an urea injector, a selective catalytic reduction (SCR) catalyst, an ammonia oxidation (AMOₓ) catalyst, a Low Temperature NOₓ adsorber (LT-NA), and a lean-NOₓ trap (LNT).

In another aspect is provided a method for treating an exhaust gas stream comprising hydrocarbons, carbon monoxide, and/or NOR, the method comprising passing the exhaust gas stream through the catalytic article, or the exhaust gas treatment system as disclosed herein. In some embodiments, the exhaust gas stream comprises hydrocarbons and carbon monoxide, hydrocarbons and NOₓ, or carbon monoxide and NOₓ.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein.

In order to provide an understanding of embodiments of the disclosure, reference is made to the appended drawings, in which reference numerals refer to components of exemplary embodiments of the disclosure. The drawings are exemplary only, and should not be construed as limiting the disclosure. The disclosure described herein is illustrated by way of example and not by way of limitation in the accompanying figures. For simplicity and clarity of illustration, features illustrated in the figures are not necessarily drawn to scale. Further, where considered appropriate, reference labels have been repeated among the figures to indicate corresponding or analogous elements.

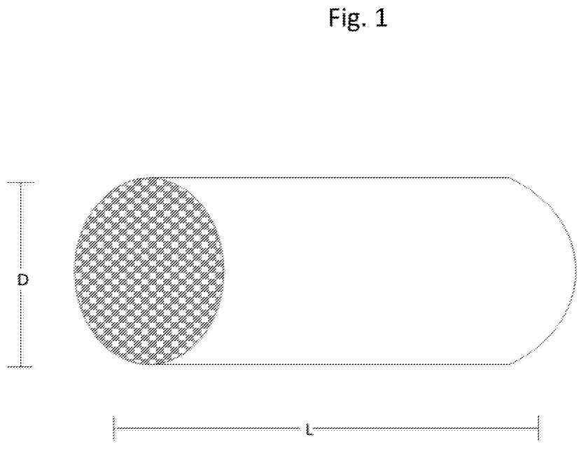

FIG. 1 depicts a perspective view of a honeycomb-type substrate which may comprise a catalyst (i.e., a selective catalytic reduction catalyst) washcoat composition in accordance with some exemplary embodiments.

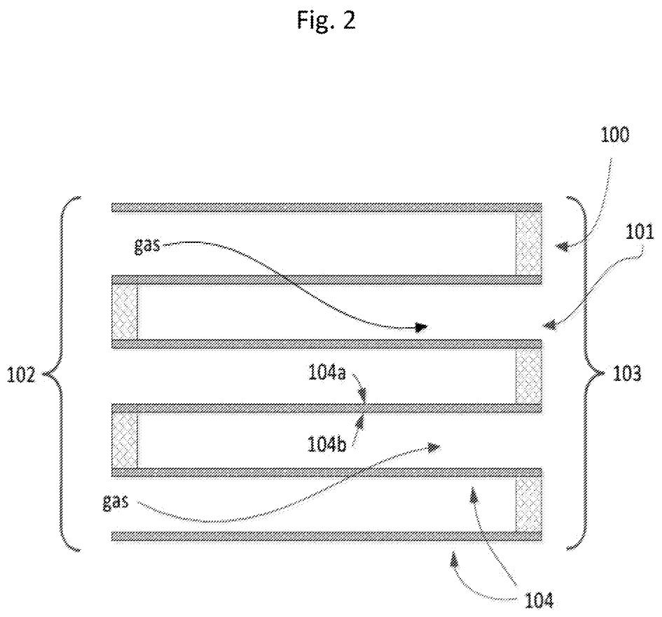

FIG. 2 depicts a cross-sectional view of a section of an exemplary wall-flow filter substrate.

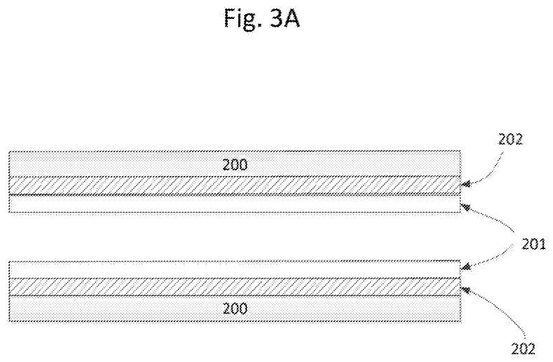

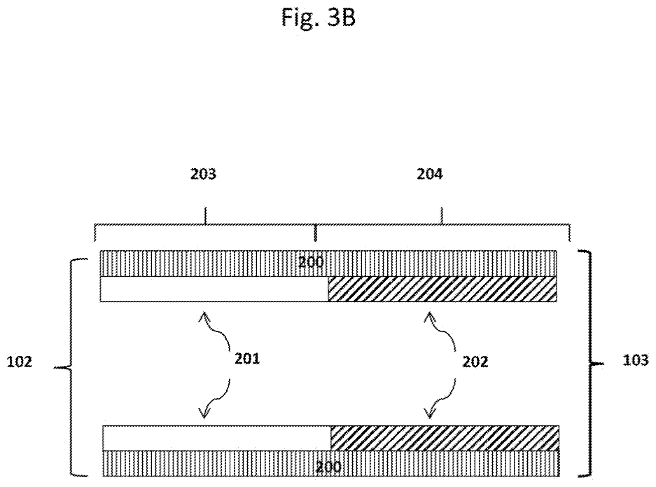

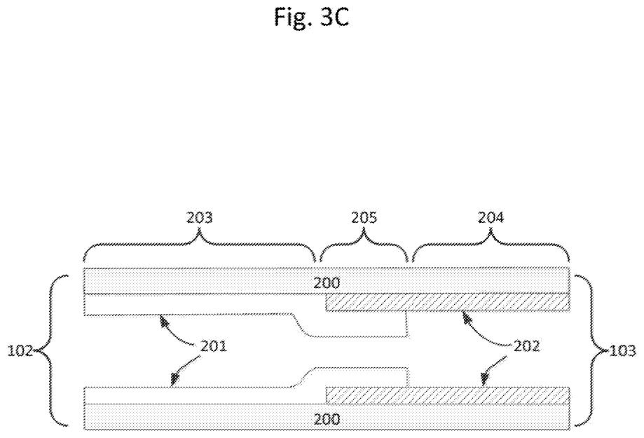

FIG. 3A depicts a cross-sectional view of an exemplary embodiment of a layered catalytic article.

FIG. 3B depicts a cross-sectional view of an exemplary embodiment of a zoned catalytic article.

FIG. 3C depicts a cross-sectional view of an exemplary embodiment of a layered and zoned catalytic article.

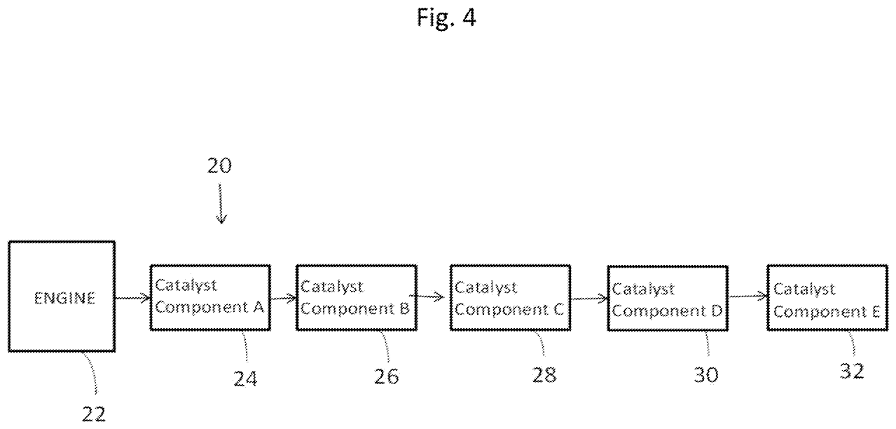

FIG. 4 depicts an emission treatment system comprising an exemplary diesel oxidation catalyst article.

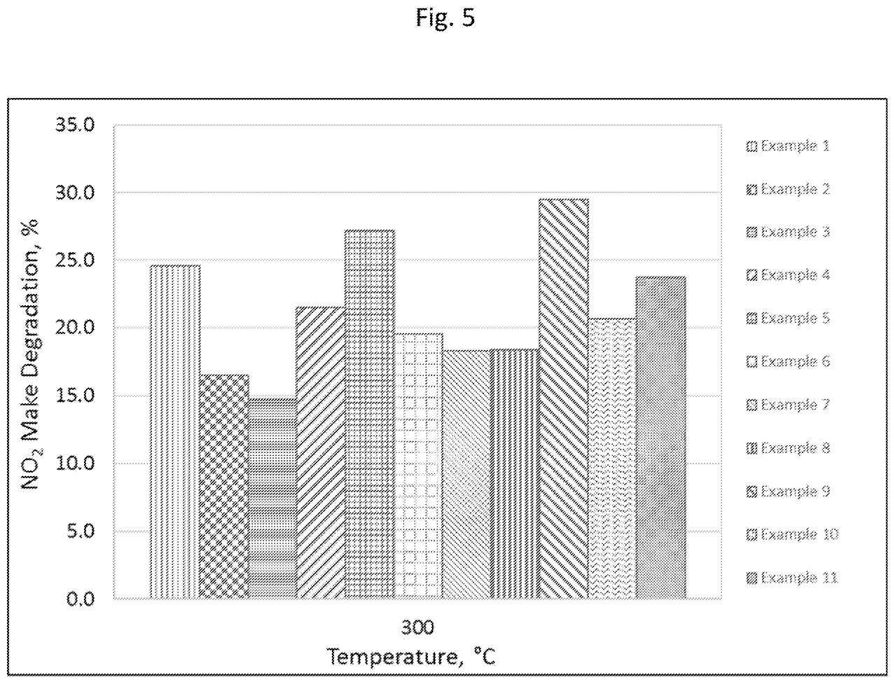

FIG. 5 depicts NO₂ make degradation of exemplary embodiments.

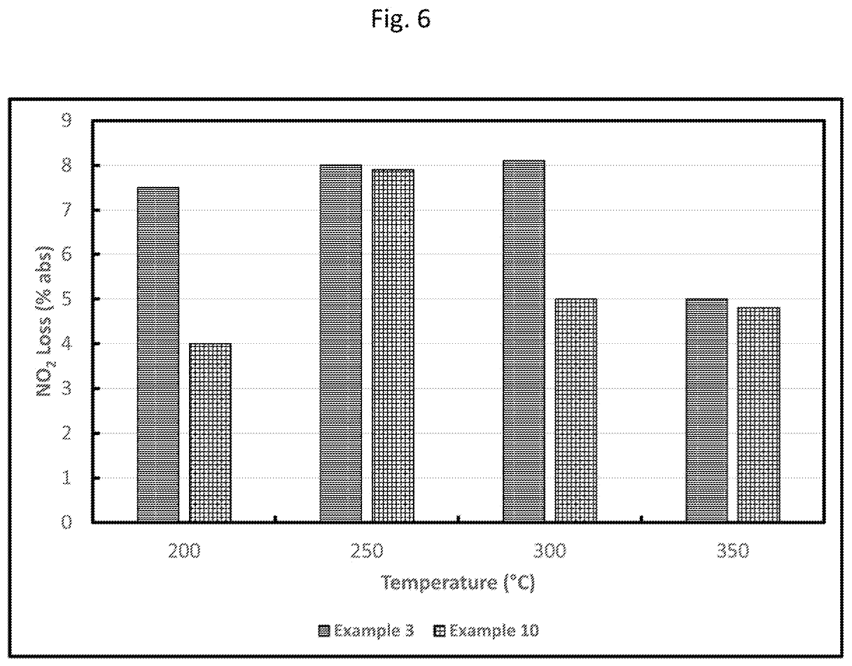

FIG. 6 depicts NO₂ make degradation at various temperatures for exemplary embodiments.

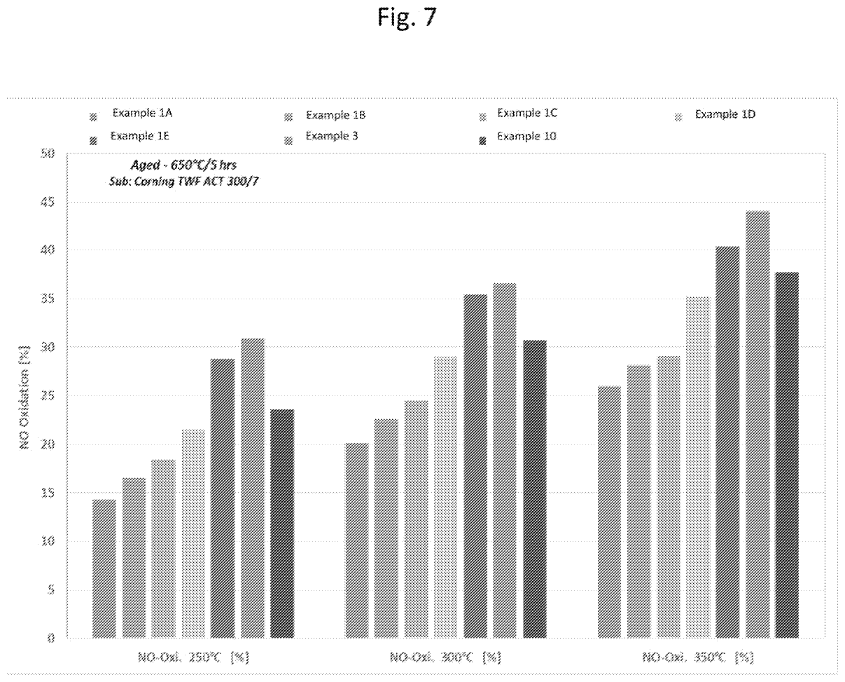

FIG. 7 depicts NO oxidation performance for exemplary embodiments.

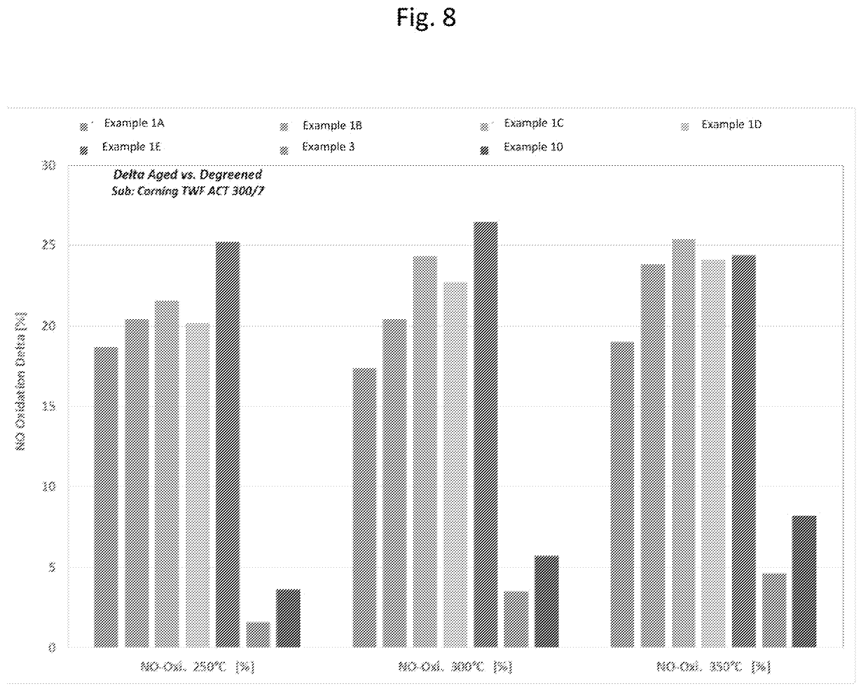

FIG. 8 depicts the change in NO oxidation performance for exemplary degreened and aged embodiments.

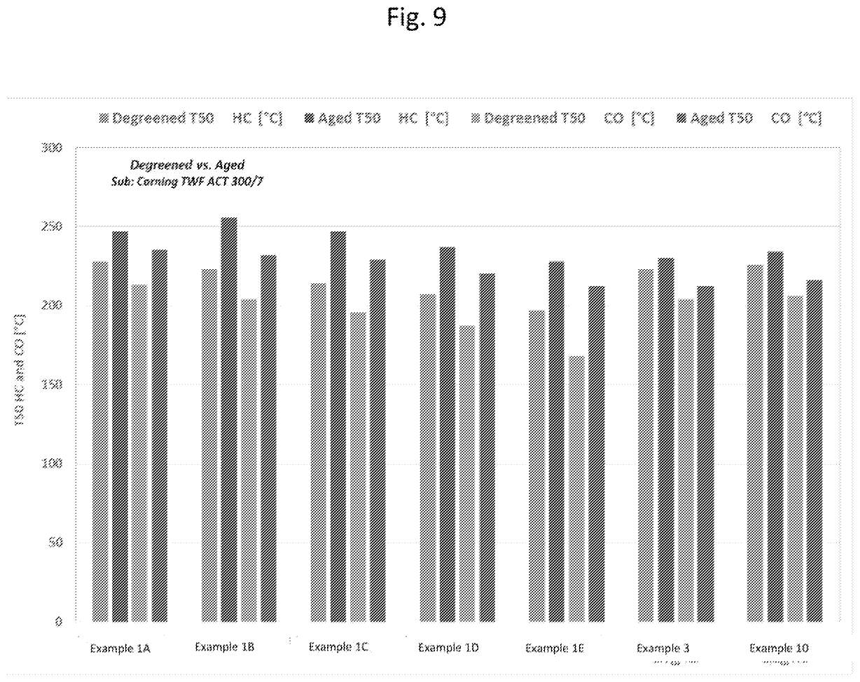

FIG. 9 depicts hydrocarbon and carbon monoxide oxidation performance for exemplary degreened and aged embodiments.

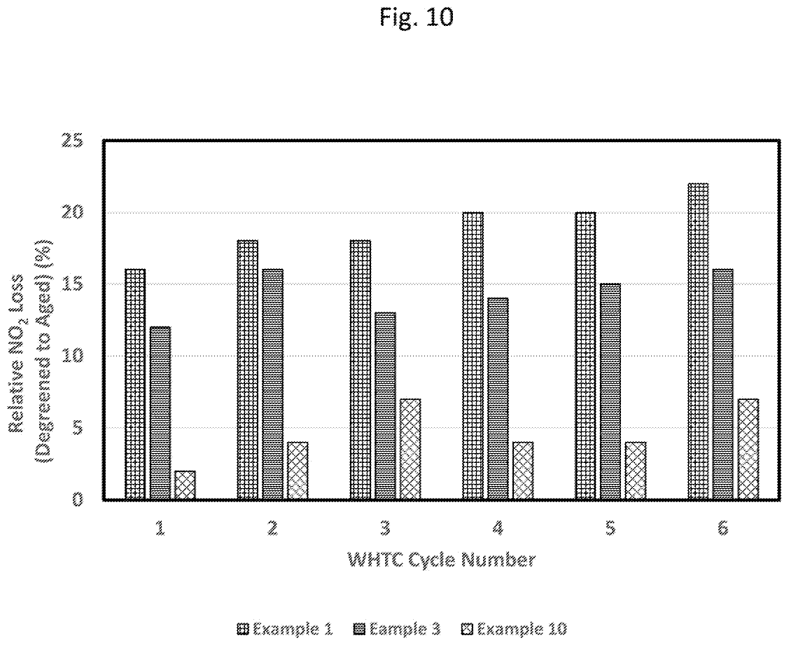

FIG. 10 depicts the change in NO oxidation performance for exemplary degreened and aged embodiments over multiple engine test cycles.

Disclosed herein are catalysts, catalyst articles, and catalyst systems comprising such catalyst articles suitable for oxidation of one or more exhaust gas components (e.g., CO, hydrocarbons, and NOₓ). In some aspects are catalysts comprising a plurality of platinum group metal particles having a multi-modal distribution of particle sizes, and which exhibit enhanced stability with respect to oxidation performance after degreening and/or aging, as compared to conventional oxidation catalysts.

### Definitions

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

Any ranges cited herein are inclusive. The term “about” used throughout is used to describe and account for small variations. For instance, “about” may mean the numeric value may be modified by ±5%, ±4%, ±3%, ±2%, ±1%, ±0.5%, ±0.4%, ±0.3%, ±0.2%, ±0.1% or ±0.05%. Numeric values modified by the term “about” include the specific identified value. For example, “about 5.0” includes 5.0.

The term “abatement” means a decrease in the amount, caused by arty means.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

The term “catalyst” refers to a material that promotes a chemical reaction. The catalyst includes the “catalytically active species” and the “support” that carries or supports the active species. For example, refractory metal oxide particles may be a support for platinum group metal catalytic species.

The term “catalytic article” in the disclosure means an article comprising a substrate having a catalyst coating composition.

As used herein, the phrase “catalyzed soot filter” refers to a wall-flow monolith. A wall-flow filter comprises of alternating inlet channels and outlet channels, where the inlet channels are plugged on the outlet end and the outlet channels are plugged on the inlet end.

A soot-carrying exhaust gas stream entering the inlet channels is forced to pass through the filter walls before exiting from the outlet channels. In addition to soot filtration and regeneration, a catalyzed soot filter may carry oxidation catalysts to oxidize CO and hydrocarbons to CO₂ and H₂O, or oxidize NO to NO₂ to accelerate the downstream SCR catalysis or to facilitate the oxidation of soot particles at lower temperatures. An SCR catalyst composition can also be coated directly onto a wall-flow filter, which is called SCRoF.

As used herein, the phrase “catalyst system” refers to a combination of two or more catalysts, for example, a combination of a first low-temperature NO adsorber (LI-NA) catalyst and a second catalyst which may be a diesel oxidation catalyst, a INT, or a SCR catalyst article. The catalyst system may alternatively be in the form of a washcoat in which the two catalysts are mixed together or coated in separate layers

The term “configured” as used in the description and claims is intended to be an open-ended term as are the terms “comprising” or “containing”. The term “configured” is not meant to exclude other possible articles or elements. The term “configured” may be equivalent to “adapted”.

As used herein, a “diesel oxidation catalyst” converts hydrocarbons and carbon monoxide in the exhaust gas of a diesel engine, as well as oxidizing nitric oxide (NO) to nitrogen dioxide (NO₂). For example, a diesel oxidation catalyst may comprise one or more platinum group metals such as palladium and/or platinum; a support material such as alumina; a zeolite for hydrocarbon storage; and optionally, promoters and/or stabilizers.

In general, the term “effective” means, for example, from about 35% to 100% effective, for instance from about 40%, about 45%, about 50%, or about 55% to about 60%, about 65%, about 70%, about 75%, about 80%, about 85%, about 90%, or about 95%, regarding the defined catalytic activity or storage/release activity, by weight or by moles.

The term “exhaust stream” or “exhaust gas stream” refers to any combination of flowing gas that may contain solid or liquid particulate matter. The stream comprises gaseous components and may be, for example, exhaust of a lean burn engine, which may contain certain non-gaseous components such as liquid droplets, solid particulates, and the like. The exhaust gas stream of a combustion engine may further comprises combustion products (CO₂ and H₂O), products of incomplete combustion (carbon monoxide (CO) and hydrocarbons), oxides of nitrogen (NOₓ), combustible and/or carbonaceous particulate matter (soot), and un-reacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

The term “functional article” in the disclosure means an article comprising a substrate having a functional coating composition disposed thereon, such as a catalyst and/or sorbent coating composition.

As used herein, “impregnated” or“impregnation” refers to permeation of the catalytic material into the porous structure of the support material.

As used herein. “LNT” refers to a lean NOₓ trap, which is a catalyst containing a, platinum group metal, ceria, and an alkaline earth trap material suitable to adsorb NOₓ during lean conditions (for example, BaO or MgO). Under rich conditions, NOₓ is released and reduced to nitrogen.

As used herein, the terms “nitrogen oxides” and “NOₓ” designate the oxides of nitrogen, such as NO, NO₂, or N₂O.

The terms “on” and “over” in reference to a coating layer nay be used synonymously. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “promoted” refers to a component that is intentionally added to a molecular sieve material, such as, for example, through ion exchange, as opposed to impurities inherent in the molecular sieve.

As used herein, the term “selective catalytic reduction” (SCR) refers to the catalytic process of reducing oxides of nitrogen to dinitrogen (N₂) using a nitrogenous reductant.

“Substantially free” means “little or no” or “no intentionally added” and also permits having only trace and/or inadvertent amounts. For instance, in certain embodiments, “substantially free” means less than 2 wt % (weight %), less than 1.5 wt %, less than 1.0 wt %, less than 0.5 wt %, less than 0.25 wt %, or less than 0.01 wt %, based on the weight of the indicated total composition.

As used herein, the term “substrate” refers to the monolithic material onto which the catalyst composition, that is, catalytic coating, is disposed, for example in the form of a washcoat. In one or more embodiments, the substrates are flow-through monoliths and monolithic wall-flow filters. Flow-through and wall-flow substrates are also taught, for example, in International Application Publication No, WO2016/070090, which is incorporated herein by reference. A washcoat is formed by preparing a slurry containing a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry containing a certain solid content (e.g., 20%-90% by weight) of particles in a liquid vehicle, which is then coated onto a substrate and dried to provide a washcoat layer.

As used herein, the term “support” refers to any high surface area material, usually a refractory metal oxide material, upon which a catalytic precious metal is applied.

As used herein, the term “washcoat” has its usual meaning in the art of a thin, adherent coating of a catalytic or other material applied to a substrate material, such as a honeycomb-type substrate, which is sufficiently porous to permit the passage of the gas stream being treated. The washcoat containing the platinum group metal particles can optionally comprise a binder selected from silica, alumina, titania, zirconia, cerin, or a combination thereof. The loading of the binder is about 0.1 to 10 wt. based on the weight of the washcoat. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size) and/or may differ in the chemical catalytic functions.

“Weight percent (wt %),” if not otherwise indicated, is based on an entire composition free of any volatiles, that is, based on dry solids content. Unless otherwise indicated, all parts and percentages are by weight.

As used herein, “space velocity” is the number of volumes of gas or liquid that pass over or through one unit volume (as of, e.g., a catalyst) per unit time.

A selective catalytic reduction catalyst is a catalyst capable of selectively reducing nitrogen oxides.

Ammonia oxidation catalysts are catalysts capable of oxidizing ammonia.

Low Temperature NOₓ adsorbers absorb NOₓ at a lower temperature typically associated with the cold start period of a diesel engine and release absorbed NOₓ at elevated temperatures typically associated with more efficient reduction by a selective catalytic reduction catalyst.

All methods described herein can be performed in any suitable order unless otherwise indicated herein or otherwise clearly contradicted by context. The use of any and all examples, or exemplary language “such as”) provided herein, is intended merely to better illuminate the materials and methods and does not pose a limitation on the scope unless otherwise claimed. No language in the specification should be construed as indicating any non-claimed element as essential to the practice of the disclosed materials and methods. All U.S. patent applications, Pre-Grant publications and patents referred to herein are hereby incorporated by reference in their entireties.

Oxidation Catalyst Composition

In one aspect, an oxidation catalyst composition comprises a plurality of platinum group metal particles having a multi-modal distribution of particle sizes, the plurality of platinum group metal particles comprising a first population of platinum group metal particles having a range of particle sizes of from about 0.5 to about 3 am; and a second population of platinum group metal particles having a range of particle sizes of from about 4 to about 15 nm.

Platinum Group Metal (PGM)

Platinum group metals include platinum (Pt), palladium (Pd), ruthenium (Ru), rhodium (Rh), osmium (Os), iridium (Ir), and mixtures thereof. The platinum group metal may be in metallic form, with zero valence, or the platinum group metal may be in an oxide form. In some embodiments, the platinum group metal is a metal or an oxide thereof (e.g., including, but not limited to, platinum or an oxide thereof). Advantageously, the platinum group metal(s) is/are substantially in fully reduced form, meaning that at least about 90% of the platinum group metal content is reduced to the metallic form (platinum group metal (0)). In some embodiments, the amount of platinum group metal in fully reduced form is even higher, e.g., at least about 92%, at least about 94%, at least about 95%, at least about 96%, at least about 97%, at least about 98%, or at least about 99% of the platinum group metal is in fully reduced form. The amount of platinum group metal (0) can be determined using ultrafiltration, followed by Inductively Coupled Plasma/Optical Emission Spectrometry (ICP-OES), or by X-Ray photoelectron spectroscopy (XPS).

In some embodiments, the platinum group metal comprises platinum, palladium, ruthenium, rhodium, iridium, or a combination thereof. In some embodiments, the platinum group metal comprises platinum, palladium, or a combination thereof. Exemplary weight ratios for such Pt/Pd combinations include weight ratios of about 1:10 to about 10:1 Pt:Pd, such as equal to or greater than about 1:1 Pt:Pd, equal to or greater than about 1.5:1 Pt:Pd, or equal to or greater than about 2:1 Pt:Pd. In certain embodiments, the platinum group metal is Pd. In certain embodiments, the platinum group metal is Pt.

The concentration of the platinum group metal (e.g., Pt and/or Pd) present in an oxidation catalyst composition can vary but may be from about 1 wt % to about 10 wt % relative to the weight of the composition.

PGM Particles

Platinum group metal particles are particles comprising one or more platinum group metal. The size of the platinum group metal particles in the catalyst composition as disclosed herein can vary. As disclosed herein, the oxidation catalyst composition comprises a plurality of platinum group metal particles having a multi-modal distribution of particle sizes.

As used herein, “particle size” refers to the smallest diameter sphere that will completely enclose the particle, and this measurement relates to an individual particle as opposed to an agglomeration of two or more particles. Particle size may be measured by laser light scattering techniques, with dispersions or dry powders, for example according to ASTM method D4464. Particle size may also be measured by Scanning Electron Microscopy (SEM) or Transmission Electron Microscopy (TEM) for submicron size particles; or by a particle size analyzer for support-containing particles (micron size).

In addition to TEM, carbon monoxide (CO) chemisorption may be used for determination of average particle size. This technique may not differentiate between various platinum group metal species (e.g., Pt, Pd, etc., as compared to XRD, TEM, and SEM) and only determines the average particle size. To determine average particle size by CO chemisorption, samples of catalyst washcoat were ground, and a small (˜100 mg) quantity was analyzed by means of pulsed CO injection as follows: Pretreatment: drying at 150° C. in helium, followed by heating at 400° C. in a 5% hydrogen in nitrogen atmosphere; CO Chemisorption: sample pulsed at room temperature with 10% CO in helium.

As used herein, “particle size distribution” defines the relative amount of particles in a population of particles having particle sizes within a range.

As used herein, “multi-modal distribution of particle sizes” refers to a continuous probability distribution with two or more modes, which appear as two or more distinct peaks (local maxima) in the probability density function. This may be visualized by plotting the frequency against the log of the particle size for the particle population. Distributions of particle sizes and percentages of particles having sizes within a particular range can be determined, e.g., from TEM or SEM by coating calcined supported platinum group metal particles onto a substrate. For example, the calcined supported platinum group metal particles on a substrate can be directly analyzed by TEM or SEM (looking at the coated substrate) or can be analyzed by scraping or otherwise removing at least a portion of the calcined supported platinum group metal particles from the substrate and obtaining an image of the scraped/removed supported platinum group metal particles.

In some embodiments, the plurality of platinum group metal particles comprise a first population and second population of platinum group metal particles having different size ranges. In some embodiments, the plurality of platinum group metal particles comprise a first population having a range of particle sizes of from about 0.5 nm to about 3 nm and a second population of platinum group metal particles having a range of particle sizes of from about 4 nm to about 15 nm. In some embodiments, the second population of platinum group metal particles may be colloidal platinum group metal particles.

In some embodiments, the first population of platinum group metal particles and the second population of platinum group metal particles each have an average particle size. In some embodiments, the first population of platinum group metal particles has an average particle size of about 1 nm. In some embodiments, the second population of platinum group metal particles has an average particle size of about 6 nm.

As used herein, the term “average particle size” refers to a characteristic of particles that indicates, on average, the diameter of the particles, “Average particle size” is synonymous with D₅₀, meaning half of the population of particles has a particle size above this point, and half below. D₉₀ particle size distribution indicates that 90% of the particles (by number) have a Feret diameter below a certain size. Average particle size can be measured by, for example, transmission electron microscopy (TEM) by visually examining a TEM image, measuring the diameter of the particles in the image, and calculating the average particle size of the measured particles based on magnification of the TEM image.

Reference herein to average particle size reflects the average particle size of fresh and/or calcined material, e.g., determined after calcination of the panicles, but prior to aging of the particles. By “fresh” it is meant that the particles have not been subjected to temperatures greater than about 500° C. in some embodiments, the oxidation catalyst composition is fresh. In other embodiments, the oxidation catalyst composition may be referred to as degreened. As used herein, the term “degreened.” refers to a catalyst composition that has been subjected to a temperature of about 500-550° C. for a period of time (e.g., for about 1 to 5 hours) with engine exhaust or simulated exhaust gas. In some embodiments, the oxidation catalyst composition may be referred to as aged. As used herein, the term “aged” refers to a catalyst composition that has been subjected to temperatures of about 650° C. or greater (e.g., about 650° C., 700° C., 800° C. 900° C. or 1000° C.) for a period of time (e.g., from about 5 hours to about 100 hours, or from about 100 hours to about 1000 hours). As will be recognized by one of skill in the art, subjecting a platinum group metal particle to degreening or aging conditions may induce changes to particle sizes as described herein above.

In some embodiments, the particle populations can be characterized by at least 80% of the particles have a particle size within 50 percent of the average particle size for the particle population, or within 20 percent, or within 15 percent, within 10 percent, or within percent (i.e., wherein at least 80% of all particles in the population have a particle size within the given percentage range around the average particle size). In other embodiments, at least 85%, 90%, 95%, 96%, 97%, 98%, or 99% of all particles fall within these ranges. In some embodiments, the particle populations comprise particles wherein at least 80% of the particles have a particle size within about 1 nm of the average particle size, or within about 2 nm of the average particle size.

In some embodiments, first population of platinum group metal particles has a particle size distribution characterized by an average particle size of about 1 nm and at least 80% of the first population of platinum group metal particles (or at least 85%, 90%, 95%, 96%, 97%, 98%, 99%, or 100%) have a particle size within 1 mu of the average particle size, e.g., in the range of from about 0.001, from about 0.01 nm, or from about 0.1, to about 2 nm.

In some embodiments, the second population of platinum group metal particles has a particle size distribution characterized by an average particle size of about 6 ran and at least about 80% of the second population of platinum group metal particles (or at least 85%, 90%, 95%, 96%, 97%, 98%, 99%, or 100%) have a particle size within about 2 nm of the average particle size e.g., in the range of from about 4 am, about 5 nm, about 6 nm, about 7 nm, or about 8 nm.

The relative amounts of the two populations of platinum group metal particles may vary. In some embodiments, the ratio by weight of the first population of platinum group metal particles to the second population of platinum group metal particles is from about 10:90 to about 90:10. In some embodiments, the ratio by weight of the first population of platinum group metal particles to the second population of platinum group metal particles is from about 50:50 to about 90:10. In some embodiments, the ratio by weight of the first population of platinum group metal particles to the second population of platinum group metal particles is from about 50:50 to about 75:25.

The average particle size for the plurality of platinum group metal particles (i.e., the overall average size of particles for the two populations combined) may vary, depending both on the ratio of the two populations and the average size of particles within each population. In some embodiments, the plurality of platinum group metal particles has an average particle size of from about 3 to about 12 nm, for example, from about 3 to about 10 nm; from about 3 to about 8 nm; from about 3 to about 6 nm; or from about 3 to about 5 nm.

Refractory Metal Oxide Support Materials

In some embodiments, the oxidation catalyst composition further comprises at least one refractory metal oxide support material. As used herein, “refractory metal oxide” refers to porous metal-containing oxide materials exhibiting chemical and physical stability at high temperatures, such as the temperatures associated with diesel engine exhaust. Exemplary refractory oxides include alumina, silica, zirconia, Mania, ceria, and physical mixtures or chemical combinations thereof, including atomically-doped combinations and including high surface area or activated compounds such as activated alumina Exemplary aluminas include large pore boehmite, gamma-alumina, and delta/theta alumina. Useful commercial aluminas include activated aluminas, such as high bulk density gamma-alumina, low or medium bulk density large pore gamma-alumina, and low bulk density large pore boehmite and gamma-alumina.

High surface area refractory oxide supports, such as alumina support materials, also referred to as “gamma alumina.” or “activated alumina,” may exhibit a BET surface area in excess of 60 m²/g, often up to about 200 m²/g or higher. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. In some embodiments, the active alumina has a specific surface area of 60 to 350 m²/g and in some embodiments 90 to 250 m²/g.

In some embodiments, the refractory metal oxide comprises alumina (Al₂O₃), silica (SiO₂), zirconia (ZrO₂), titania (TiO₂), ceria (CeO₂), or combinations thereof. Combinations may be in the form of physical or chemical mixtures. Mixed metal oxides include, but are not limited to, zirconia-alumina, coria-zirconia, coria-alumina, lanthana-alumina, baria-alumina, and silica-alumina.

In certain embodiments, metal oxide supports useful in the oxidation catalyst compositions disclosed herein are doped alumina materials, such as Si-doped alumina materials (including, but not limited to 1-10% SiO₂—Al₂O₃), doped titania materials, such as Si-doped titania materials (including, but not limited to 1-10% SiO₂-TiO₂) or doped zirconia materials, such as Si-doped ZrO₂ (including, but not limited to 5-30% SiO₂—ZrO₂). Accordingly, in some embodiments, the at least one refractory metal oxide support comprises SiO₂-doped Al₂O₃, SiO₂-doped TiO₂, and/or SiO₂-doped. ZrO₂.

The oxidation catalyst composition may comprise any of the above-named refractory metal oxides and in any amount. For example, refractory metal oxides in the catalyst composition may comprise from about 15 wt %, about 20 wt %, about 25 wt %, about 30 wt %, about 35 wt %, about 40%, about 45%, or about 50 wt %, to about 55 wt %, about 60 wt %, about 65 wt %, about 70 wt %, about 75 wt %, about 80 wt %, about 85 wt %, about 90 wt %, about 95 wt %, or about 99 wt %, based on the total dry weight of the catalyst composition. The catalyst composition may, for example, comprise from about 10 to about 99 wt % of TiO₂ or SiO₂-doped TiO₂, from about 15 to about 95 wt % of TiO₂ or SiO₂-doped TiO₂, or from about 20 to about 85 wt % of TiO₂ or SiO₂-doped TiO₂.

In some embodiments, the first population of platinum group metal particles and the second population of platinum group metal particles are both dispersed on the same refractory metal oxide support. In some embodiments, the first population of platinum group metal particles and the second population of platinum group metal particles are each dispersed on separate refractory metal oxide supports, wherein the first population of platinum group metal particles is dispersed on a first refractory metal oxide support, and the second population of platinum group metal particles is dispersed on a second refractory metal oxide support, wherein the first refractory metal oxide support and the second refractory metal oxide support are each independently selected.

In some embodiments, the first refractory metal oxide support and the second refractory metal oxide support are two different refractory metal oxide materials (e.g., as a non-limiting example, the first refractory metal oxide support may be alumina, and the second refractory metal oxide support may be titania). In some embodiments, the first refractory metal oxide support and the second refractory metal oxide support both comprise the same refractory metal oxide support material. In some embodiments, the first and the second refractory metal oxide supports both comprise TiO₂ or SiO₂-doped TiO₂.

Dispersing Platinum Group Metal Particles on Refractory Metal Oxide Support

Oxidation catalyst compositions as disclosed herein may comprise two populations of platinum group metal particles associated with one or more support materials, e.g., refractory metal oxide supports. Methods for dispersing platinum group metal particles on a refractory metal oxide support may vary depending, e.g., on the size range of the platinum group metal particles.

In some embodiments, a first population of platinum group metal particles having a range of particle sizes of from about 0.5 to about 3 nm is dispersed on a refractory metal oxide support. In some embodiments, such supported particles are prepared by impregnating the refractory metal oxide support material in particulate form with a platinum group metal precursor solution, such as an aqueous solution of water soluble platinum group metal compounds or complexes, such as palladium or platinum in the firm of nitrate, acetate, a tetraammine complex (e.g., chloride nitrate, acetate, and the like), or a combination thereof. After impregnation and drying, calcining is optionally performed to convert the platinum group metal compound(s) to a more catalytically active, zero valence form. Multiple platinum group metals (e.g., platinum and palladium) can be impregnated at the same time or separately, and can be impregnated into the same refractory metal oxide support particles or separate refractory metal oxide support particles, using, for example an incipient wetness technique.

Incipient wetness impregnation techniques, also called capillary impregnation or dry impregnation, are commonly used for the synthesis of such heterogeneous materials, i.e., catalysts. In some embodiments, the aqueous platinum group metal compound solution is added to the refractory metal oxide support containing the same pore volume as the volume of the solution that was added. Capillary action draws the solution into the pores of the refractory metal oxide support. Solution added in excess of the support pore volume may cause the solution transport to shift from a capillary action process to a diffusion process, which is much slower. In some embodiments, the support particles are dry enough to absorb substantially all of the solution to form a moist solid.

In some embodiments, the impregnated refractory metal oxide support can then be dried, such as by heat treating the particles at elevated temperature e.g., 100-150° C.) for a period of time (e.g., 1-3 hours) to drive off the volatile components within the solution, and then calcined to convert the platinum group metal components to a more catalytically active form, depositing the active platinum group metal on the refractory metal oxide support surface. An exemplary calcination process involves heat treatment in air at a temperature of about 400-550° C. for 0.5-3 hours. The maximum loading may be limited by the solubility of the precursor in the solution. The concentration profile of the impregnated material may depend on the mass transfer conditions within the pores during impregnation and drying. The above process can be repeated as needed to reach the desired level of platinum group metal impregnation.

In some embodiments, a second population of platinum group metal particles having a range of particle sizes of from about 4 to about 15 nm is dispersed on a refractory metal oxide support. The dispersal can be achieved during production of the platinum group metal particles (direct dispersion) and/or after production of the platinum group metal particles (subsequent dispersion). Each method is outlined herein below.

Direct Dispersion on Support Material

In some embodiments, platinum group metal particles can be dispersed on a refractory metal oxide support materials during production of the platinum group metal particles. One exemplary method for producing platinum group metal particles in the desired size range (e.g., of from about 4 to about 15 nm) is described in International Application Publication No. WO2016/057692, which is incorporated herein by reference in its entirety. Briefly, as disclosed therein, platinum group metal precursors (e.g., salts of platinum group metals) are combined with a dispersion medium and a polymer suspension stabilizing agent and the resulting solution is combined with a reducing agent to provide a platinum group metal particle colloidal dispersion. To disperse the platinum group metal particles on a refractory metal oxide support, the refractory metal oxide support material can be added to the dispersion in which platinum group metal particles are formed at any stage of the process (e.g., along with the platinum group metal precursors or along with the reducing agent) to disperse the particles on the refractory metal oxide support material. Prior to this addition, the dispersion of platinum group metal particles can be optionally concentrated or diluted. Exemplary methods of impregnating supports with colloidal platinum group metal materials are described in US2017/0304805 to Xu et al, and US2019/0015781 to Wei et al., both of which are incorporated by reference herein in their entirety.

In some embodiments, the platinum group metal particles are isolated and subsequently dispersed on the refractory metal oxide support material. Methods for isolating particles from a dispersion generally are known and, in some embodiments, isolated platinum group metal particles can be obtained by heating and/or applying vacuum to a dispersion containing particles or otherwise processing the dispersion to ensure removal of at least a substantial portion of the solvent therefrom. Following isolation of the platinum group metal particles, the platinum group metal particles and the refractory metal oxide support can be mixed (e.g., with water) to form a dispersion wherein the platinum group metal particles can be dispersed on the refractory metal oxide support material. Such methods, providing for dispersion on a refractory metal oxide support material after the platinum group metal particles are formed, are commonly described as incipient wetness techniques. This process may be repeated several times to achieve a targeted platinum group metal concentration on the support.

The colloidal platinum group metal (e.g., platinum) may be prepared from a platinum group metal precursor by reduction, as described above. The platinum group metal precursor can, in some embodiments, be selected from ammine complex salts, hydroxyl salts, nitrates, carboxylic acid salts, ammonium salts, and oxides (e.g., selected from Pt(NH₃)₄(OH)₂, Pt nitrate, Pt citrate, and the like).

The reducing agent can be any reagent effective to reduce platinum group metals to metallic (platinum group metal (0)) form and is advantageously soluble in the dispersion medium (e.g., water-soluble). Although not limited thereto, in certain embodiments, the reducing agent may be an organic reducing agent. Suitable reducing agents are, for example, hydrogen, hydrazine, urea, formaldehyde, formic acid, ascorbic acid, citric acid, glucose, sucrose, xylitol, meso-erythritol, sorbitol, glycerol, maltitol or oxalic acid. Further, liquid reducing agents such as monovalent alcohols from the group of methanol, ethanol, 1-propanol, iso-propanol, 1-butanol, 2-butanol, 2-methyl-propan-1-ol, allyl alcohol and diacetone alcohol, and mixtures and combinations thereof may be employed. Further suitable liquid reducing agents are divalent alcohols, such as ethylene glycol, propylene glycol, diethylene glycol, tetraethylene glycol or dipropylene glycol. Other reducing agents are hydrazine-based reducing agents, such as formic hydrazide and hydroxyethylhydrazine, and natural plant-based polyphenol acids, such as tannic acid and garlic acid. In some embodiments, the reducing agent is ascorbic acid. The reducing agent may be present in an amount of about 1-10% by weight in the dispersion.

The dispersion medium may be, for example, at least one polar solvent selected from water, alcohols (including polyols), dimethyl formamide (DMF), and combinations thereof. The alcohol may, in some embodiments, be selected from methanol, ethanol, 1-propanol, 2-propanol, 1-butanol, 2-butanol, iso-butanol, hexanol, octanol, and combinations thereof. The polyol may, in some embodiments, be selected from glycerol, glycol, ethylene diethylene glycol, triethylene glycol, butanediol, tetraethylene glycol, propylene glycol, polyethylene glycol, polypropylene glycol, 1,2-pentadiol, 1,2-hexadiol, and combinations thereof. In some embodiments, the dispersion medium comprises water. Some embodiments are aqueous colloidal dispersions.

The stabilizing agent may be a polymer suspension stabilizing agent that is soluble in the dispersion medium and/or used to improve dispersion of the platinum group metal particles (e.g., where the dispersion medium comprises water, the stabilizing agent may be a water-soluble polymer suspension stabilizing agent). The composition and the size (e.g., weight average-molecular weight, MO of the polymer can vary. In some embodiments, the polymer has a M_{w} of 2,000 to 2,000,000 Da, such as a M_{w} of 10,000 to 60,000 Da (measured using Gel Permeation Chromatography (GPC)). Suitable polymers include, for example, polyvinyl pyrrolidone (PVP), a copolymer including vinyl pyrrolidone as a first polymerization unit, and a fatty acid-substituted or unsubstituted polyoxyethylene.

Polyvinyl pyrrolidone may be useful as the polymer suspension stabilizing agent. The polymer suspension stabilizing agent may be present in an amount of about 0.1 to 20, such as about 5 to 10, parts by weight based on 100 parts of the dispersion medium by weight.

In some embodiments, the refractory metal oxide support material dispersed with platinum group metal particles is then dried at elevated temperature (e.g., 100-150° C.) for a period of time (e.g., 1-3 hours). Optionally, refractory metal oxide support material dispersed with platinum group metal particles are calcined to drive off volatile components. An exemplary calcination process involves heat treatment in air at a temperature of about 400-550° C. for 1-3 hours. The above process can be repeated as needed to reach the desired level of impregnation.

In some embodiments, the two populations of platinum group metal particles may be dispersed on the same refractory metal oxide support, or on separate refractory metal oxide support materials, which may have the same composition or different compositions. In embodiments where the two populations of platinum group metal particles are dispersed on the same refractory metal oxide support material, the dispersion may be performed sequentially, and in either order (e.g., impregnation with a platinum group metal solution, followed by colloidal platinum group metal impregnation, or colloidal platinum group metal impregnation followed by impregnation with a platinum group metal solution). Further, calcining, milling, both, or neither may be performed after each platinum group metal population dispersion is conducted.

Catalytic Articles

In another aspect, an oxidation catalyst article comprises a substrate having an inlet end and an outlet end defining an overall length, and a catalytic coating comprising an oxidation catalyst composition as disclosed herein disposed on at least a portion thereof.

Substrates

In some embodiments, an oxidation catalyst compositions is disposed on a substrate to form a catalytic article. Catalytic articles comprising substrates may be employed as part of an exhaust gas treatment system (e.g., catalyst articles including, but not limited to, articles including the oxidation catalyst compositions disclosed herein). In some embodiments, useful substrates are 3-dimensional, having a length and a diameter and a volume, similar to a cylinder. The shape does not necessarily have to conform to a cylinder. In some embodiments, the length is an axial length defined by an inlet end and an outlet end.

In some embodiments, the substrate for the disclosed composition(s) may be constructed of any material typically used for preparing automotive catalysts and may comprise a metal or ceramic honeycomb structure. In some embodiments, the substrate may provide a plurality of wall surfaces upon which the washcoat composition is applied and adhered, thereby acting as a substrate for the catalyst composition.

Ceramic substrates may be made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate, and the like.

Substrates may also be metallic, comprising one or more metals or metal alloys. A metallic substrate may include any metallic substrate, such as those with openings or “punch-outs” in the channel walls. The metallic substrates may be employed in various shapes such as pellets, compressed metallic fibers, corrugated sheet, and monolithic foam. Specific examples of metallic substrates include heat-resistant, base-metal alloys, especially those in which iron is a substantial or major component. Such alloys may contain one or more of nickel, chromium, and aluminum, and the total of these metals may advantageously comprise at least about 15 wt % (weight percent) of the alloy, for instance, about 10 wt % to about 25 wt % chromium, about 1 wt % to about 8 wt % of aluminum, and from 0 wl % to about 20 wt % of nickel, in each case based on the weight of the substrate. Examples of metallic substrates include those having straight channels; those having protruding blades along the axial channels to disrupt gas flow and to open communication of gas flow between channels; and those having blades and also holes to enhance gas transport between channels allowing for radial gas transport throughout the monolith.

Any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). Another exemplary substrate is of the type have a plurality of fine, substantially parallel gas flow passages extending along the longitudinal axis of the substrate where, for example, each passage may be blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. In some embodiments, the substrate is a flow-through substrate. Flow-through substrates and wall-flow filters will be further discussed herein below.

Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which may be essentially straight paths from their fluid inlet to their fluid outlet, are defined by walls on or in which a catalytic coating is disposed so that gases flowing through the passages contact the catalytic material. The flow passages of the flow-through substrate may be thin-walled channels, which can be of any suitable cross-sectional shape and size such as trapezoidal, rectangular, square, sinusoidal, hexagonal, oval, circular, etc. The flow-through substrate can be ceramic or metallic as described above.

Flow-through substrates can, for example, have a volume of from about 50 in³ to about 1200 in³, a cell density (inlet openings) of from about 60 cells per square inch (cpsi) to about 500 cpsi or up to about 900 cpsi, for example from about 200 to about 400 cpsi and a wall thickness of from about 50 microns to about 200 microns or to about 400 microns.

Wall-Flow Filter Substrates

In some embodiments, the substrate is a wall-flow filter, which may have a plurality of fine, substantially parallel gas flow passages extending along the longitudinal axis of the substrate. In some embodiments, each passage is blocked at one end of the substrate body, with alternate passages blocked at opposite end-faces. Such monolithic wall-flow filter substrates may contain up to about 900 or more flow passages (or “cells”) per square inch of cross-section. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes. The wall-flow filter substrate can be ceramic or metallic as described above.

Referring to FIG. 1, the exemplary waif-flow filter substrate has a cylindrical shape and a cylindrical outer surface having a diameter D and an axial length L. A cross-section view of a monolithic wall-flow filter substrate section is illustrated in FIG. 2, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

The wall-flow filter article substrate may have a volume of, for example, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³. Wall-flow filter substrates may have a wall thickness from about 50 microns to about 2000 microns, for example from about 50 microns to about 450 microns or from about 151) microns to about 400 microns.

The walls of the wall-flow filter may be porous and may have a wall porosity of at least about 40% or at least about 50% with an average pore diameter of at least about 10 microns prior to disposition of the functional coating. For example, the wall-flow filter article substrate in some embodiments has a porosity of ≥40%, ≥50%, ≥60%, ≥65% or ≥70%. For example, the wall-flow filter article substrate will have a wall porosity of from about 50%, about 60%, about 65% or about 70% to about 75% and an average pore diameter of from about 10, or about 20, to about 30, or about 40 microns prior to disposition of a catalytic coating. The terms “wall porosity” and “substrate porosity” mean the same thing and are interchangeable. Porosity is the ratio of void volume (or pore volume) divided by the total volume of a substrate material. Pore size and pore size distribution may, for example, be determined by Hg porosimetry measurement.

Substrate Coating Process

In some embodiments, a substrate as described herein is coated with an oxidation catalyst composition as disclosed herein. The coatings are “catalytic coating compositions” or “catalytic coatings.” A “catalyst composition” and a “catalytic coating composition” are synonymous.

In some embodiments, the oxidation catalyst composition is prepared and coated on a substrate as described herein. In some embodiments, this method can comprise mixing the catalyst composition (or one or more components of the catalyst composition) as generally disclosed herein with a solvent (e.g., water) to form a slurry for purposes of coating a catalyst substrate. In addition to the catalyst composition, the slurry may optionally contain various additional components. Additional components may include, for example, binders as described herein above, additives to control, e.g., pH and viscosity of the slurry. Additional components can include hydrocarbon storage components (e.g., zeolites), associative thickeners, and/or surfactants (including anionic, cationic, non-ionic or amphoteric surfactants). An exemplary pH range for the slurry is about 3 to about 6. Addition of acidic or basic species to the slurry can be carried out to adjust the pH accordingly. For example, in some embodiments, the pH of the slurry is adjusted by the addition of aqueous acetic acid.

The slurry can be milled to reduced particle size and to enhance mixing of the particles and formation of a homogenous material. The milling can be accomplished in a ball mill, continuous mill, or other similar equipment, and the solids content of the slurry may be, e.g., about 20-60 wt % or about 20-40 wt %. In some embodiments, the post-milling slurry is characterized by a D₉₀ particle size of about 1 micron to about 40 microns, such as 2 microns to about 20 microns, or about 4 microns to about 15 microns.

In some embodiments, the oxidation catalyst compositions may be applied in the form of one or more washcoats. A washcoat may be formed by preparing a slurry containing a specified solids content (e.g., about 10 to about 60% by weight) of catalyst composition (or one or more components of the catalyst composition) in a liquid vehicle, which may then be applied to a substrate using any washcoat technique known in the art and dried and calcined to provide a coating layer. If multiple coatings are applied, the substrate may be dried and/or calcined after each washcoat is applied and/or after the number of desired multiple washcoats are applied. In some embodiments, the catalytic material(s) are applied to the substrate as a washcoat.

A washcoat may be formed by preparing a slurry containing a specified solids content (e.g., 30-90% by weight) of catalyst material in a liquid vehicle, which is then coated onto the substrate (or substrates and dried to provide a washcoat layer. To coat the wall flow substrates with the catalyst material of some embodiments, the substrates can be immersed vertically in a portion of the catalyst slurry such that the top of the substrate is located just above the surface of the slurry. In this manner, slurry contacts the inlet face of each honeycomb wall, but is prevented from contacting the outlet face of each wall. The sample may be left in the slurry for about 30 seconds. The substrate may be removed from the slurry, and excess slurry may be removed from the wall flow substrate first by allowing it to drain from the channels, then by blowing with compressed air (against the direction of slurry penetration), and then by pulling a vacuum from the direction of stiffly penetration. By using this technique, the catalyst slurry may permeate the walls of the substrate, yet the pores are may not be occluded to the extent that undue back pressure will build up in the finished substrate. As used herein, the term “permeate” when used to describe the dispersion of the catalyst slurry on the substrate, means that the catalyst composition is dispersed throughout the wall of the substrate.

In some embodiments, the coated substrate is dried at an elevated temperature (e.g., 100-150° C.) for a period of time (e.g., 1-3 hours) and then calcined by heating, e.g., at 400-600° C., for about 10 minutes to about 3 hours. Following drying and calcining, the final washcoat coating layer can be viewed as essentially solvent-free. After calcining, the catalyst loading can be determined through calculation of the difference in coated and uncoated weights of the substrate. As will be apparent to those of skill in the art, the catalyst loading can be modified by, for example, altering the slurry rheology. In addition, the coating/drying/calcining process can be repeated as needed to build the coating to the desired loading level or thickness.

After calcining, the catalyst loading obtained by the above described washcoat technique can be determined through calculation of the difference in coated and uncoated weights of the substrate. As will be apparent to those of skill in the art, the catalyst loading can be modified by, for example, altering the slurry rheology. In addition, the coating/drying/calcining process to generate a washcoat layer (coating layer) can be repeated as needed to build the coating to the desired loading level or thickness, meaning more than one washcoat may be applied.

In some embodiments, the catalytic coating may comprise one or more coating layers, where at least one layer comprises the present catalyst composition or one or more components of the catalyst composition. The catalytic coating may comprise one or more thin, adherent coating layers disposed on and in adherence to least a portion of a substrate. The entire coating may comprise the individual coating layers.

In some embodiments, oxidation catalyst articles may include the use of one or more catalyst layers and combinations of one or more catalyst layers. Catalytic materials may be present on the inlet side of the substrate wall alone, the outlet side alone, both the inlet and outlet sides, or the wall itself may consist all, or in part, of the catalytic material. The catalytic coating may be on the substrate wall surfaces and/or in the pores of the substrate walls, that is “in” and/or “on” the substrate walls. Thus, the phrase “a washcoat disposed on the substrate” means on any surface, for example on a wall surface and/or on a pore surface.

The washcoat(s) can be applied such that different coating layers may be in direct contact with the substrate. In some embodiments, one or more “undercoats” may be present, so that at least a portion of a catalytic coating layer or coating layers are not in direct contact with the substrate but rather, are in contact with the undercoat. One or more “overcoats” may also be present, so that at least a portion of the coating layer or layers are not directly exposed to a gaseous stream or atmosphere but rather, are in contact with the overcoat.

In some embodiments, the present oxidation catalyst composition may be in a top coating layer over a bottom coating layer. A catalyst composition may be present in a top and a bottom layer. Any one layer may extend the entire axial length of the substrate, for instance a bottom layer may extend the entire axial length of the substrate and a top layer may also extend the entire axial length of the substrate over the bottom layer. In some embodiments, each of the top and bottom layers may extend from either the inlet or outlet end.

For example, both bottom and top coating layers may extend from the same substrate end where the top layer partially or completely overlays the bottom layer and where the bottom layer extends a partial or full length of the substrate and where the top layer extends a partial or full length of the substrate. In some embodiments, a top layer may overlay a portion of a bottom layer. For example, a bottom layer may extend the entire length of the substrate and the top layer may extend about 10%, about 20%, about 30%, about 40%, about 50%, about 60%, about 70%, about 80%, or about 90% of the substrate length, from either the inlet or outlet end.

In some embodiments, a bottom layer may extend about 10%, about 15%, about 25%, about 30%, about 40%, about 45%, about 50%, about 55%, about 60%, about 65%, about 70%, about 75%, about 80%, about 85%, or about 95% of the substrate length from either the inlet end or outlet end and atop layer may extend about 10%, about 15%, about 25%, about 30%, about 40%, about 45%, about 50%, about 55%, about 60%, about 65%, about 70%, about 75%, about 80%, about 85%, or about 95% of the substrate length from either the inlet end of outlet end, wherein at least a portion of the top layer overlays the bottom layer. This “overlay” zone may, for example, extend from about 5% to about 80% of the substrate length, for example about 5%, about 10%, about 20%, about 30%, about 40%, about 50%, about 60%, or about 70% of the substrate length.

In some embodiments, the catalytic coating may advantageously be “zoned,” comprising zoned catalytic layers, that is, where the catalytic coating contains varying compositions across the axial length of the substrate. This may also be described as “laterally zoned”. For example, a layer may extend from the inlet end towards the outlet end extending about 10%, about 20%, about 30%, about 40%, about 50%, about 60%, about 70%, about 80%, or about 90% of the substrate length. Another layer may extend from the outlet end towards the inlet end extending about 10%, about 20%, about 30%, about 40%, about 50%, about 60%, about 70%, about 80%, or about 90% of the substrate length. Different coating layers may be adjacent to each other and not overlay each other. In some embodiments, different layers may overlay a portion of each other, providing a third “middle” zone. The middle zone may, for example, extend from about 5% to about 80% of the substrate length, for example about 5%, about 10%, about 20%, about 30%, about 40%, about 50%, about 60%, or about 70% of the substrate length.

Zones may be defined by the relationship of coating layers. With respect to different coating layers, there are a number of possible zoning configurations. For example, there may be an upstream zone and a downstream zone, there may be an upstream zone, a middle zone and a downstream zone, there may four different zones, etc. Where two layers are adjacent and do not overlap, there are upstream and downstream zones. Where two layers overlap to a certain degree, there are upstream, downstream and middle zones. Where for example, a coating layer extends the entire length of the substrate and a different coating layer extends from the outlet end a certain length and overlays a portion of the first coating layer, there are upstream and downstream zones.

In some embodiments, the first washcoat is disposed on the catalyst substrate from the inlet end to a length of from about 10% to about 50% of the overall length; and the second washcoat is disposed on the catalyst substrate from the outlet end to a length of from about 50% to about 90% of the overall length. In some embodiments, the first washcoat is disposed on the catalyst substrate from the outlet end to a length of from about 10% to about 50% of the overall length; and wherein the second washcoat is disposed on the catalyst substrate from the inlet end to a length of from about 50% to about 90% of the overall length.

FIGS. 3a, 3b, and 3c depict exemplary coating layer configurations with two coating layers. Shown are substrate walls 200 onto which coating layers 201 (top coat) and 202 (bottom coat) are disposed. This is a simplified illustration, and in the case of a porous wall-flow substrate, not shown are pores and coatings in adherence to pore walls and not shown are plugged ends. In FIG. 3a, coating layers 201 and 202 each extend the entire length of the substrate with top layer 201 overlaying bottom layer 202. The substrate of FIG. 3a does not contain a zoned coating configuration. FIG. 3b is illustrative of a zoned configuration having a coating layer 202 which extends from the outlet about 50% of the substrate length to form a downstream zone 204, and a coating layer 201 which extends from the inlet about 50% of the substrate length, providing an upstream zone 203. In FIG. 3c, bottom coating layer 202 extends from the outlet about 50% of the substrate length and top coating layer 201 extends from the inlet greater than 50% of the length and overlays a portion of layer 202, providing an upstream zone 203, a middle overlay zone 205 and a downstream zone 204. FIGS. 3a, 3b, and 3c may be useful to illustrate SCR catalyst composition coatings on a wall-through substrate or a flow-through substrate.

Loading, of catalytic coatings on a substrate may depend on substrate properties such as porosity and wall thickness. For example, wall-flow filter catalyst loading may be lower than catalyst loadings on a flow-through substrate. Catalyzed wall-flow filters are disclosed, for instance, in U.S. Pat. No. 7,229,597, which is incorporated herein by reference in its entirety. In describing the quantity of washcoat or catalytic metal components or other components of the composition, it may be convenient to use units of weight of component per unit volume of catalyst substrate. Therefore, the units, grains per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. Concentration of a catalyst composition, or any other component, on a substrate refers to concentration per any one three-dimensional section or zone, for instance any cross-section of a substrate or of the entire substrate. The total platinum group metal loading of the platinum group metal particle-containing composition (e.g., plurality of Pt particles) on the catalyst substrate, such as a monolithic flow-through substrate, may, for example, be front about 0.5 g/ft³ to about 200 g/ft³.

In some embodiments, an oxidation catalyst article is a diesel oxidation catalyst article. In some embodiments, a plurality of platinum group metal particles are disposed on the substrate at a loading of from about 5 g/ft³ to about 200 g/ft³ (e.g., about 5 g/ft³ to about 50 g/ft³ and, in certain embodiments, about 10 g/ft³ to about 50 g/ft³, or about 10 g/ft³ to about 100 g/ft³).

In some embodiments, an oxidation catalyst article is a catalyzed soot filler article. In some embodiments, a plurality of platinum group metal particles are disposed on the substrate at a loading of from about 0.5 g/ft³ to about 30 g/ft³, for example, from about 0.5 g/ft³, about 1.0 g/ft³, about 1.5 g/ft³, about 2.0 g/ft³, about 2.5 g/ft³, about 3.0 g/ft³, or about 3.5 g/ft³, to about 5 g/ft³, about 10 g/ft³, about 15 g/ft³, about 20 g/ft³, about 25 g/ft³, or about 30 g/ft³. In some embodiments, a plurality of platinum group metal particles are disposed on the substrate at a loading of from about 1.2 g/ft³ to about 3.6 g/ft³, from about 1.5 g/ft³ g/ft³ to about 2.7 or from about 1.7 g/ft³ to about 2.2 g/ft³.

It is noted that these weights per unit volume are may be calculated by weighing catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

In some embodiments, the level of hydrocarbons, methane, or CO present in the exhaust gas stream is reduced by at least about 30%, or at least about 50%, or at least about 70%, or at least about 75%, or at least about 80%, or at least about 90%, or at least about 95% compared to the level of hydrocarbons or CO present in the exhaust gas stream prior to contact with the catalyst article. In some embodiments, the temperature for converting hydrocarbons, e.g., methane, or CO using the catalyst article described in the present embodiments may range from about 250° C. to about 650° C., from about 300° C. to about 600° C. or from about 350° C. to about 550° C.

In some embodiments, the efficiency for reduction of hydrocarbon and/or CO level is measured in terms of the conversion efficiency. In some embodiments, conversion efficiency is measured as a function of light-off temperature (i.e., T₅₀). The light-off temperature is the temperature at which the catalyst composition is able to convert 50% of hydrocarbons or carbon monoxide to carbon dioxide and water Typically, the lower the measured light-off temperature for any given catalyst composition, the more efficient the catalyst composition is to carry out the catalytic reaction, e.g., hydrocarbon conversion.

In some embodiments, the reduction of NOₓ level is measured in terms of the NO₂/NOₓ ratio. In some embodiments, the oxidation catalyst article, after aging at 650° C. for 5 hours, exhibits a NO₂/NOₓ ratio of from about 40 to about 55% when disposed on a 1″ ×3″ flow-through substrate at a platinum group metal loading of 1.7 g/ft³ and subjected to a feed gas containing 600 ppm of NO, 10% 02, 5% CO₂, 5% H₂O, and 33 ppm propane at a temperature of 350° C. and space velocity of 50,000 per hour.

In some embodiments, the oxidation catalyst article, after degreening at 550° C. for 5 hours, has a first NO₂/NOₓ ratio; and after aging at 650° C. for 5 hours, has a second NO₂/NOₓ ratio; wherein the second NO₂/NOₓ ratio is at least about 80% of the first NO₂/NOₓ ratio, when the oxidation catalyst article is disposed on a 1″×3″ flow-through substrate at a platinum group metal loading of 1.7 g/ft³ and subjected to a feed gas containing 600 ppm of NO, 10% 02, 5% CO₂, 5%1120, and 33 ppm propane at a temperature of 350° C. and a space velocity of 50,000 per hour.

Exhaust Gas Treatment Systems

In some embodiments, an exhaust gas treatment system comprises an oxidation catalyst article as disclosed herein. The engine can be, e.g., a diesel engine which operates at combustion conditions with air in excess of that required for stoichiometric combustion, i.e. lean conditions, in other embodiments, the engine can be a gasoline engine (e.g., a lean burn gasoline engine) or an engine associated with a stationary source (e.g., electricity generators or pumping stations). Exhaust gas treatment systems may contain more than one catalytic article positioned downstream from the engine in fluid communication with the exhaust gas stream. A system may contain, for example, an oxidation catalyst article as disclosed herein (e.g., a diesel oxidation catalyst), a selective catalytic reduction catalyst (SCR), and/or one or more articles including a reductant injector, a soot filter, an ammonia oxidation catalyst (AMOx), or a lean NOₓ trap (LNT). An article containing a reductant injector is a reduction article. A reduction system includes a reductant injector and/or a pump and/or a reservoir, etc. The present treatment system may further comprise a soot filter and/or an ammonia oxidation catalyst. A soot filter may be uncatalysed or may be catalyzed, such as a catalyzed soot filter as disclosed herein. For example, the present treatment system may comprise, from upstream to downstream—an article containing a diesel oxidation catalyst, a catalyzed soot filter, a urea injector, a SCR article and an article containing an AMOx. A lean NOₓ trap (LNT) may also be included.

The relative placement of the various catalytic components present within the emission treatment system can vary. In some embodiments, the exhaust gas stream is received into the article(s) or treatment system by entering the upstream end and exiting the downstream end. The inlet end of a substrate or article is synonymous with the “upstream” end or “front” end. The outlet end is synonymous with the “downstream” end or “rear” end. The treatment system may be, for example, downstream of and in fluid communication with an internal combustion engine.

One exemplary emission treatment system is illustrated in FIG. 4, which depicts a schematic representation of an emission treatment system 20. As shown, the emission treatment system can include a plurality of catalyst components in series downstream of an engine 22, such as a lean burn engine. One or more of the catalyst components may comprise the oxidation catalyst composition of the disclosure as set forth herein (e.g., a diesel oxidation catalyst, a catalyzed soot filter, or both). The oxidation catalyst composition of the disclosure could be combined with additional catalyst materials and could be placed at various positions in comparison to the additional catalyst materials. FIG. 4 illustrates five catalyst components, 24, 26, 28, 30, 32 in series; however, the total number of catalyst components can vary and five components is merely one example.

For example, Table 1 presents various exhaust gas treatment system configurations. It is noted that each catalyst may be, for example, connected to the next catalyst via exhaust conduits such that the engine is upstream of catalyst A, which is upstream of catalyst B, which is upstream of catalyst C, which is upstream of catalyst D, which is upstream of catalyst E (when present). The reference to Components A-E in the table can be cross-referenced with the same designations in FIG. 4.

The LNT catalyst noted in Table 1 can be any catalyst conventionally used as a NOₓ trap, and may comprise NOₓ-adsorber compositions that include base metal oxides (BaO, MgO, CeO₂, and the like) and a platinum group metal for catalytic NO oxidation and reduction (e.g., Pt and Rh).

The LT-NA catalyst noted in Table 1 can be any catalyst that can adsorb NOₓ (e.g., NO or NO₂) at low temperatures (<250° C.) and release it to the gas stream at high temperatures (>250° C.). The released NOₓ may be converted to N₂ and H₂O over a down-stream SCR or SCRoF catalyst. For example, a LT-NA catalyst comprises Pd-promoted zeolites or Pd-promoted refractory metal oxides.

Reference to SCR in the table refers to an SCR catalyst. Reference to SCRoF (or SCR on finer) refers to a particulate or soot filter (e.g., a filter), which can include an SCR catalyst composition.

Reference to AMOx in the table refers to an ammonia oxidation catalyst, which can be provided, for example, downstream of an oxidation catalyst to remove slipped ammonia from the exhaust gas treatment system. In some embodiments, the AMOx catalyst may comprise a platinum group metal component. In some embodiments, the AMOx catalyst may comprise a bottom coat with platinum group metal and a top coat with SCR functionality.

As recognized by one skilled in the art, in the configurations listed in Table 1, any one or more of components A, B, C, D, or E can be disposed on a particulate filter, such as a wall flow filter, or on a flow-through honeycomb substrate. In some embodiments, an engine exhaust system comprises one or more catalyst compositions mounted in a position near the engine (in a close-coupled position, CC), with additional catalyst compositions in a position underneath the vehicle body (in an underfloor position, UF). In some embodiments, the exhaust gas treatment system may further comprise a urea injection component.

TABLE 1
Exemplary exhaust gas treatment system configurations

| Component | Component | Component | Component | Component |
|---|---|---|---|---|
| A | B | C | D | E |
| diesel | SCR | Optional | — | — |
| oxidation | | AMOx | | |
| catalyst | | | | |
| diesel | SCRoF | Optional | — | — |
| oxidation | | AMOx | | |
| catalyst | | | | |
| diesel | SCRoF | SCR | Optional | — |
| oxidation | | | AMOx | |
| catalyst | | | | |
| diesel | SCR | SCRoF | Optional | — |
| oxidation | | | AMOx | |
| catalyst | | | | |
| diesel | catalyzed soot | SCR | Optional | — |
| oxidation | filter | | AMOx | |
| catalyst | | | | |
| LNT | catalyzed soot | SCR | Optional | — |
| | filter | | AMOx | |
| LNT | SCRoF | SCR | Optional | — |
| | | | AMOx | |

Method of Treating an Exhaust Gas Stream

In another aspect, a method for treating an engine exhaust gas stream comprising hydrocarbons and/or carbon monoxide (CO), and/or NOₓ is provided. In some embodiments, the method comprises contacting the exhaust gas stream with the catalytic article of the present disclosure, or the emission treatment system of the present disclosure.

In some embodiments, hydrocarbons and CO present in the exhaust gas stream of any engine can be converted to carbon dioxide (CO₂) and water. For example, hydrocarbons present in an engine exhaust gas stream may comprise C₁-C₆ hydrocarbons i.e., lower hydrocarbons), such as methane, although higher hydrocarbons (greater than C₆) may also be present. In some embodiments, the method comprises contacting the gas stream with the catalytic article or the exhaust gas treatment system of the present disclosure for a time and at a temperature sufficient to reduce the levels of CO and/or hydrocarbons in the gas stream.

In some embodiments, NOₓ species, such as NO, present in the exhaust gas stream of an engine can be converted (oxidized) to NO₂. In some embodiments, the method comprises contacting the gas stream with the catalytic article or the exhaust gas treatment system of the present disclosure for a time and at a temperature sufficient to oxidize at least a portion of the NO present in the gas stream to NO₂.

The present articles, systems, and methods may be suitable for treatment of exhaust gas streams from mobile emissions sources such as trucks and automobiles. In some embodiments, articles, systems, and methods are also suitable for treatment of exhaust streams from stationary sources such as power plants.

Some additional exemplary embodiments include without limitation:

1. An oxidation catalyst composition, the composition comprising a plurality of platinum group metal particles having a multi-modal distribution of particle sizes, the plurality of platinum group metal particles comprising: a first population of platinum group metal particles having a range of particle sizes of from about 0.5 nm to about 3 nm; and a second population of platinum group metal particles having a range of particle sizes of from about 4 nm to about 15 nm.

2. The oxidation catalyst composition of embodiment 1, wherein the first population of platinum group metal particles has a particle size distribution characterized by an average particle size of about 1 nm and at least about 80% of the first population of platinum group metal particles have a particle size within about 1 nm of the average particle size.

3. The oxidation catalyst composition of embodiment 1 or 2, wherein the second population of platinum group metal particles has a particle size distribution characterized by an average particle size of about 6 nm and at least about 80% of the second population of platinum group metal particles have a particle size within about 2 nm of the average particle size.

4. The oxidation catalyst composition of any of embodiments 1 to 3, wherein the ratio by weight of the first population of platinum group metal particles to the second population of platinum group metal particles is from about 10:90 to about 90:10.

5. The oxidation catalyst composition of any of embodiments 1 to 4, wherein the ratio by weight of the first population of platinum group metal particles to the second population of platinum group metal particles is from about 50:50 to about 90:10.

6. The oxidation catalyst composition of any of embodiments 1 to 5, wherein the ratio by weight of the first population of platinum group metal particles to the second population of platinum group metal particles is from about 50:50 to about 75:25.

7. The oxidation catalyst composition of any of embodiments 1 to 6, wherein the plurality of platinum group metal particles has an average particle size of from about 3 nm to about 12 nm.

8. The oxidation catalyst composition of any of embodiments 1 to 7, wherein the plurality of platinum group metal particles has an average particle size of from about 3 nm to about 10 nm; front about 3 nm to about 8 nm; from about 3 nm to about 6 nm; or from about 3 nm to about 5 nm.

9. The oxidation catalyst composition of any of embodiments 1 to 8, wherein at least about 90% of the platinum group metal of one or more of the first and second populations of platinum group metal particles is in hilly reduced form.

10. The oxidation catalyst composition of any of embodiments 1 to 9, wherein the platinum group metal of one or more of the first and second populations of platinum group metal particles comprises platinum, palladium, ruthenium, rhodium, iridium, or a combination thereof.

11. The oxidation catalyst composition of any of embodiments 1 to 10, wherein the platinum group metal of one or more of the first and second populations of platinum group metal particles comprises platinum, palladium, or a combination thereof.

12. The oxidation catalyst composition of any of embodiments 1 to 11, wherein the platinum group metal of one or more of the first and second populations of platinum group metal particles is platinum.

13. The oxidation catalyst composition of any of embodiments 1 to 12, further comprising at least one refractory metal oxide support.

14. The oxidation catalyst composition of embodiment 13, wherein the at least one refractory metal oxide support comprises alumina (Al₂O₃), silica (SiO₂), zirconia (ZrO₂), titanic (TiO₂), ceria (CeO₂), or combinations thereof.

15. The oxidation catalyst composition of embodiment 13 or 14, wherein the at least one refractory metal oxide support comprises SiO₂-doped Al₂O₃, SiO₂-doped TiO₂, or SiO₂-doped ZrO₂.

16. The oxidation catalyst composition of any of embodiments 13 to 15, wherein the at least one refractory metal oxide support comprises Al₂O₃ doped with 1-10% SiO₂, TiO₂ doped with 1-20% SiO₂, or ZrO₂ doped with 1-30% SiO₂.

17. The oxidation catalyst composition of any of embodiments 13 to 16, wherein the first population of platinum group metal particles and the second population of platinum group metal particles are bath dispersed on the same refractory metal oxide support.

18. The oxidation catalyst composition of any of embodiments 14 to 17, wherein the first population of platinum group metal particles and the second population of platinum group metal particles are each dispersed on separate refractory metal oxide supports, wherein the first population of platinum group metal particles is dispersed on a first refractory metal oxide support, and the second population of platinum group metal particles is dispersed on a second refractory metal oxide support, wherein the first refractory metal oxide support and the second refractory metal oxide support are each independently selected.

19. The oxidation catalyst composition of embodiment 18, wherein the first refractory metal oxide support and the second refractory metal oxide support both comprise the same refractory metal oxide support material.

The oxidation catalyst composition of embodiment 19, wherein the refractory, metal oxide support material comprises TiO₂ or SiO₂ doped TiO₂.

21. An oxidation catalyst article comprising a substrate having an inlet end and an outlet end defining an overall length, and a catalytic coating comprising the oxidation catalyst composition of any one of embodiments 1 to 20 disposed on at least a portion thereof.

22. The oxidation catalyst article of embodiment 21, wherein the substrate is a flow-through monolith or a wall-flow filter.

23. The oxidation catalyst article of embodiment 21 or 22, wherein the oxidation catalyst article is a diesel oxidation catalyst article.

24. The diesel oxidation catalyst article of embodiment 23, wherein the plurality of PGM particles are disposed on the substrate at a loading of from about 5 g/ft³ to about 200 g/ft³.

25. The oxidation catalyst article of embodiment 21 or 22, wherein the oxidation catalyst article is a catalyzed soot filter article.

26. The catalyzed soot filter article of embodiment 25, wherein the plurality of PGM particles are disposed on the substrate at a loading of from about 0.5 g/ft³ to about 30 g/ft³.

27. The oxidation catalyst article of any of embodiments 21 to 26, wherein, after aging the oxidation catalyst article at 650° C. for 5 hours, the oxidation catalyst article exhibits a NO₂/NOₓ ratio of from about 40% to about 55% when subjected to a feed gas containing 600 ppm of NO, 10% 02, 5% CO₂, 5% H₂O, and 33 ppm propane at a temperature of 350° C. and space velocity of 50,000 per hour.

28. The oxidation catalyst article of any of embodiments 21 to 27, wherein after degreening at 550° C. for 5 hours, the oxidation catalyst article has a first NO₂/NOₓ ratio, and after aging at 650° C. for 5 hours, the oxidation catalyst article has a second NO₂NOₓ ratio; wherein the second NO₂/NOₓ ratio is at least about 80% of the first NO₂/NOₓ ratio; and wherein the first and second NO₂/NOₓ ratio are determined by subjecting the oxidation catalyst article to a feed gas containing 600 ppm NO, 10% 02, 5% CO₂, 5% H₂O, and 33 ppm propane at a temperature of 350° C. and space velocity of 50,000 per hour.

29. An exhaust gas treatment system comprising the oxidation catalyst article of any of embodiments 21-28, wherein the oxidation catalyst article is downstream of and in fluid communication with an internal combustion engine.

30. The exhaust gas treatment system of embodiment 29, further comprising one or more catalytic articles selected from an urea injector, a selective catalytic reduction (SCR) catalyst, an ammonia oxidation (AMOₓ) catalyst, a Low Temperature NOₓ adsorber (LT-NA), and a lean-NOₓ trap (LNT).

31. A method for treating an exhaust gas stream comprising hydrocarbons, carbon monoxide, and/or NOₓ, the method comprising passing the exhaust gas stream through the catalytic article of any of embodiments 21 to 28, or the exhaust gas treatment system of embodiment 29 or 30.

32. The oxidation catalyst article of embodiment 18, wherein the plurality of platinum group metal particles are disposed on the substrate at a loading of from about 0.5 g/ft³ to about 5 g/ft³.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various exemplary embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided.

### EXAMPLES

The following examples are intended to be illustrative and are not meant in any way to limit the scope of the disclosure. Unless otherwise noted, all parts and percentages are by weight, and all weight percentages are expressed on a dry basis, meaning excluding water content, unless otherwise indicated.

### Examples 1A-E

In Examples 1A-E, a suspension of colloidal Pt was prepared, dispersed on a titania support material, and milled. Then, catalyzed soot filter articles were prepared with a Pt loading from 1.2 g/ft³ to 3.6 g/ft³ by coating a wall flow soot filter substrate with the resulting titania supported Pt.

Specifically, Octanol (1 g) was added to water (820 g) under gentle stirring. Titania support material (310 g) was gradually added to the water/octanol mixture with stirring. Dispersant (4 g) was added to facilitate dispersion of the support within the aqueous phase. Subsequently, tartaric acid (2.3 g) was added to lower the pH to 3.8. This was followed by mixing for 30 minutes. The resulting well-dispersed slurry of the support material was transferred into a mill for reduction of the particles size down to a D₉₀ of about 5 micron. The milled slurry was transferred into a clean container, and an aqueous portion of preformed Pt material prepared according to US2017/0304805 and US2019/001578 was added at various target Pt loadings (measured in g/ft³). The average Pt particle size was 5.9 nm with a range of Pt particle sizes from 4 nm to 15 nm. The resulting slurry was then coated onto wall-flow filter substrate at a washcoat dry gain of 0.15 g/in³, followed by drying at 120° C. for 2 hours and calcination at 590° C. for one hour. Pt loadings for each example are provided in Table 2.

TABLE 2
Pt loadings of Examples 1A-E.

| Example # | Pt (g/ft³) |
|---|---|
| 1A | 1.2 |
| 1B | 1.5 |
| 1C | 1.8 |
| 1D | 2.7 |
| 1E | 3.6 |

### Example 2

In Example 2, a titania support material was impregnated with a Pt solution and milled. Then, a catalyzed soot filter article was prepared with a Pt loading of 2.8 g/ft³ by coating a wall flow soot filter substrate with the milled Pt impregnated titania support.

Specifically, titania support material (255 g) was impregnated with a solution of tetraamine platinum (II) complex (13.2 g) by adding dropwise onto the dry powder under mixing. The Pt impregnated support mixture was then added to water (260 g) to form a well-dispersed slurry. A dispersant (up to 1.5% of the solid material) was added if necessary. The pH of the slurry was adjusted down to 4.2 using tartaric acid. The well-dispersed slurry was loaded into a mill for reduction of the particles size down to a D₉₀ of about 5 micron. The resulting slurry was then coated onto wall-flow filter substrates at a washcoat dry gain of 0.15 g/in³. This was followed by drying at 120° C. for 2 hours and calcination at 590° C. for one hour. The average Pt particle size was 1.3 nm, with a range of Pt particle sizes from 0.5 nm to 3 nm.

### Examples 3-6

Catalyst compositions of Examples 3-6 were prepared by impregnating a titania support material with a Pt solution, followed by disposing Pt particles from a colloidal Pt suspension on the impregnated titania, support material using the procedures below. The ratio of impregnated. Pt (referred to herein as “Pt A”) to deposited colloidal Pt (referred to herein as “Pt B”) for the composition of each Example is provided in Table 3.

Examples 3-5 were prepared by impregnating a titania support material with a Pt solution. The resulting material was milled and used to prepare a slurry with the pH adjusted to less than 5. Colloidal Pt was then dispersed on the titania support.

Specifically, the titania support material (260 g) was impregnated with tetraamine platinum (II) complex solution (3.4, 6.7, and 10.1 g, respectively for Examples 3-5). The Pt solution was added as a wet mist to the dry powder under a medium mixing rate in a closed container. Upon completion of Pt solution addition, mixing was continued for 30 minutes. A slurry was prepared by mixing the impregnated support with water (575 g), dispersant (3.5 g) and octanol (1 g) with stirring. Subsequently, tartaric acid (2.1 g) was added to lower the pH down to 3.9, followed by mixing for 30 minutes. The well-dispersed mixture was then loaded into a mill and the particle size was reduced to a D₉₀ of about 5 micron. The milled slurry was transferred into a clean container, and an aqueous portion of preformed Pt material prepared according to US2017/0304805 and US2019/001578 was added at 90 g, 60 g, and 30 g for Examples 3, 4, and 5 respectively in order to achieve the desired target Pt loadings (measured in g/ft³). Silica sol binder (10.5 g) was added, and the resulting slurry was then coated onto wall-flow filter substrates at a washcoat dry gain of 0.15 g/in³. This was followed by drying at 120° C. for 2 hours and calcination at 590° C. for one hour.

Example 6 was prepared by impregnating a titania support material with a Pt solution as follows. Water (680 g), octanol (1 g), and dispersant (3.3 g) were mixed well under stirring for 30 minutes. The pH of the mixture was adjusted to 6.5 using monoethylamine. Tetraamine Platinum (H) complex solution (2.3 g) was added to the mixture, and the pH was adjusted to 4.3 with tartaric acid. Colloidal Pt (60 g) was then added under stirring. The well-dispersed mixture was loaded into a mill and the particle size was reduced to a D₉₀ of about 5 micron. The milled slurry was transferred into a clean container, silica sol binder (8.2 g) was added, and the resulting slurry was then coated onto wall-flow filter substrates at a washcoat dry gain of 0.15 g/in³ at 2.8 g/ft³ Pt loading. This was followed by drying at 120° C., for 2 hours and calcination at 590° C. for one hour.

### Examples 7-12

Catalyst compositions of Examples 7-12 were prepared by impregnating a titania support material with a Pt solution and dispersing colloidal Pt on a separate titania support using the procedures below. The ratio of Pt A to Pt B for the composition of each Example is provided in Table 3.

### Example 7

Tetraamine platinum complex solution (4.4 g) was diluted with 110 g of water and added as a wet mist to dry powder of titania support material (200 g) under a medium mixing rate in a closed container. Upon completion of the Pt solution addition, mixing was continued for 30 minutes. Water (365 g), octanol (0.6 g), and dispersant (2.6 g) were mixed well under stirring, and the wet Pt impregnated support material was added to the mixture under stirring. The pH was adjusted to 3.9 with tartaric acid (1 g) and the mixture was stirred for 30 minutes. The well-dispersed mixture was loaded into a mill and the particle size was reduced to a D₉₀ of about 5 micron.

10226 Separately, support material (133.5 g), water for slurrying (295 g), and dispersant (1.65 g) were mixed together under stirring for 30 minutes. Tartaric acid was added to lower the pH to 3.9, and the slurry milled to a D₉₀ of about 5 micron. To this slurry was added preformed platinum group metal material (118 g) prepared according to US2017/0304805 and US2019/001578 at the target platinum group metal loading of 15 g/ft³.

The two separate slurries were combined and silica sol binder added (19.5 g). The resulting slurry was then coated onto flow-through substrates at a washcoat dry gain of 0.85 g/in³ followed by drying at 120° C. for 2 hours and then calcination at 590° C. for one hour, as described above.

### Example 8

Tetraamine platinum complex solution (10.8 g) was diluted with 130 g of water and added as a wet mist to a dry powder of support material (205 g) under a medium mixing rate in a closed container. Upon completion of Pt solution addition, mixing was continued for 30 minutes. Water (395 g), octanol (0.6 g), and dispersant (2.6 g) were mixed well under stirring, and the wet Pt impregnated support material was added to the mixture under stirring. The pH was adjusted to 4.7 with tartaric acid (1.8 g) and the mixture was stirred for 30 minutes. The well-dispersed mixture was loaded into a mill and the particle size was reduced to a D₉₀ of about 5 micron.

Separately, support material (205 g), water for slurrying (480 g), and dispersant (2.6 g) were mixed together under stirring for 30 minutes. Tartaric acid (1 g) was added to lower the pH to 4.1, and the slurry was milled to a D₉₀ of about 5 micron. To this slurry was added preformed platinum group metal material (96 g) prepared according to US2017/0304805 and US2019/001578 at the target platinum group metal loading of 15 g/ft³.

The two separate slurries were combined and silica sol binder added (19.5 g). The resulting slurry was then coated onto flow-through substrates at a washcoat dry gain of 0.85 g/in³′ followed by drying at 120° C. for 2 hours and then calcination at 590° C. for one hour, as described above.

### Example 9

Tetraamine platinum complex solution (13.4 g) was diluted with 155 g of water and added as a wet mist to a dry powder of support material (260 g) under a medium mixing rate in a closed container. Upon completion of Pt solution addition, mixing was continued for 30 minutes. The wet Pt impregnated support powder was spread on to a ceramic tray and calcined in a furnace at 500° C. for 5 hours. Water (640 g), octanol (0.8 g), and dispersant (3.2 g) were mixed well under stirring, and the calcined Pt impregnated support material was added to the mixture under stirring. The pH was adjusted to 4.7 with tartaric acid (1.8 g), followed by stirring for 30 minutes. The well-dispersed mixture was loaded into a mill and the particle size was reduced to a D₉₀ of about 5 micron.

Separately, support material (260 g), water for slurrying (610 g), and dispersant (3.3 g) were mixed together under stirring for 30 minutes. Tartaric acid (1 g) was added to lower the pH to 4.1, and the slurry was milled to a D₉₀ of about 5 micron. To this slurry was added preformed platinum group metal material (120 g) prepared according to US2017/0304805 and US201.9/001578) at the target platinum group metal loading of 15 g/ft³. The two separate slurries were combined and silica sol binder was added (23.2 g). The resulting slurry was then coated onto flow-through substrates at a washcoat dry gain of 0.85 g/in³. This was followed by drying at 120° C. for 2 hours and then calcination at 590° C. for one hour.

### Example 10

Tetraamine platinum complex solution (10.8 g) diluted with 120 g of water was added as a wet mist to a dry powder of support material (200 g) under a medium mixing rate in a closed container. Upon completion of Pt solution addition, mixing was continued for 30 minutes. The wet Pt impregnated support powder was spread on to a ceramic tray and calcined in a furnace at 550° C. for 5 hours. Water (440 g), octanol (0.6 g), and dispersant (2.5 g) were mixed well under stirring, and the calcined Pt impregnated support material was added to the mixture under stirring. The pH was adjusted to 4.7 with tartaric acid (1.8 g), followed by stirring for 30 minutes. The well-dispersed mixture was loaded into a mill and the particle size was reduced to a D₉₀ of about 5 micron.

Separately, support material (200 g), water for slurrying (460 g), and dispersant (2.6 g) were mixed together under stirring for 30 minutes. Tartaric acid (2.1 g) was added to lower the pH to 3.5, and the slurry milled to a D₉₀ of about 5 micron. To this slurry was added preformed platinum group metal material (93 g) prepared according to US2017/0304805 and US2019/001578) at the target platinum group metal loading of 15 g/ft³. The two separate slurries were combined and silica sol binder was added (18.2 g). The resulting slurry was then coated onto flow-through substrates at a washcoat dry gain of 0.85 g/in³. This was followed by drying at 120° C. for 2 hours and then calcination at 590° C., for one hour.

### Example 11

Tetraamine platinum complex solution (10.8 g) was diluted with 120 g of water and added as a wet mist to a dry powder of support material (200 g) under a medium mixing rate in a closed container. Upon completion of Pt solution addition, mixing was continued for 30 minutes. The wet Pt impregnated support powder was spread on to a ceramic tray and calcined in a furnace at 600° C. for 5 hours. Water (495 g), octanol (0.6 g), and dispersant (2.6 g) were mixed well under stirring, and the calcined Pt impregnated support material as added to the mixture under stirring for 30 minutes.

Separately, support material (200 g), water for slurrying (520 g), and dispersant (2.6 g) were mixed together under stirring for 30 minutes. Tartaric acid (2.1 g) was added to lower the pH to 3.8, and the slurry was milled to a D₉₀ of about 5 micron. To this slurry was added preformed platinum group metal material (95 g) prepared according to US2017/0304805 and US2019/001578 at the target platinum group metal loading of 15 g/ft³. The two separate slurries were combined and silica sol binder was added (18.2 g). The resulting slurry was then coated onto flow-through substrates at a washcoat dry gain of 0.85 g/in³. This was followed by drying at 120° C. for 2 hours and then calcination at 590° C. for one hour.

### Example 12

Tetraamine platinum complex solution (15.7 g) was diluted with 185 g of water and added as a wet mist to a dry powder of support material (303.4 g) under a medium mixing rate in a closed container. Upon completion of Pt solution addition, mixing was continued for 30 minutes. The batch was divided into three equal parts, and each part of wet Pt impregnated support powder was spread onto a separate ceramic tray. The wet powders were separately calcined in a furnace at 500° C. for 5 hours, 550° C. for 5 hours, and 600° C. for 5 hours, respectively. Upon calcination, all the powders were combined into single batch and mixed thoroughly. Water (650 g), octanol (0.9 g), and dispersant (3.9 g) were mixed well under stirring, and the calcined Pt impregnated support material was added to the mixture under stirring for 30 minutes. The mixture was loaded into a mill and the particles size reduced to a D₉₀ of about 5 micron.

Separately, support material (303.2 g), water for slurrying (600 g), and dispersant (3.9 g) were mixed together under stirring for 30 minutes. Tartaric acid (1.3 g) was added to lower the pH to 4.1, and the slurry was milled to a D₉₀ of about 5 micron. To this slurry was added preformed platinum group metal material (140 g) prepared according to US2017/0304805 and US2019/001578) at the target platinum group metal loading of 15 g/ft³. The two separate slurries were combined and silica sol binder was added (19.4 g). The resulting slurry was then coated onto flow-through substrates at a washcoat dry gain of 0.55 g/in³ followed by drying at 120° C. for 2 hours and then calcination at 590° C. for one hour.

TABLE 3
Pt A/B ratios for compositions of Examples 3-12.

| Example # | Pt A:Pt B Ratio |
|---|---|
| 3 | 25:75 |
| 4 | 50:50 |
| 5 | 75:25 |
| 6 | 50:50 |
| 7 | 25:75 |
| 8 | 50:50 |
| 9 | 50:50 |
| 10 | 50:50 |
| 11 | 50:50 |
| 12 | 50:50 |

### Example 13. Diesel Oxidation Catalyst Coating Articles

Articles according to Examples 1 to 11 in diesel oxidation catalyst coating configurations were evaluated for NO₂ make degradation at 300° C. (FIG. 5). Core samples of each article were tested in a lab reactor employing a synthetic gas mix comprising of 10% oxygen, 5% carbon dioxide, 100 ppm CO, 600 ppm NO, 100 ppm hydrocarbon, 5% H₂O, with the balance nitrogen. Each sample was tested fresh, degreened, and after aging at 600° C. for 20 hours. NO oxidation stability against aging was the primary focus and the drop in activity for NO conversion to NO₂ was calculated as the NO₂ make degradation. Example 3 showed the least NO₂ make degradation, followed by Examples 2, 7, 8, 6, and 10.

### Example 14. Results for Catalyzed Soot Filter Articles (Aged)

Articles according to Examples 3 and 10 in catalyzed soot filter coating configurations were aged at 550° C. for 100 hours, then evaluated for loss of NO₂ make across a temperature range of 200-350° C. Stable NO₂ make was observed for both articles, showing a loss of 5-8% NO₂ make on aging (FIG. 6 and Table 4).

TABLE 4
NO₂ make loss on aging.

| | platinum | NO₂% | NO₂% | NO₂% | NO₂% |
|---|---|---|---|---|---|
| | group metal | loss | loss | loss | loss |
| Example | Loading | @ 200 C. | @ 250 C. | @ 300 C. | @ 350 C. |
| 3 | 1.7 g/ft³ | 7.50 | 8 | 8 | 5 |
| 10 | 2.2 g/ft3 | 4 | 7.8 | 5 | 4.8 |

### Example 15. NO % Oxidation after Aging

Catalyzed soot filter articles (Examples 1A-E, 3, and 10) were evaluated for NO % oxidation at 250° C., 300° C., and 350° C. after aging at 650° C. for 5 hours. Example 3 yielded the highest NO₂ make after aging (31-44%), while Example 10 was comparable to Example IF, (23-37%), which had a 0.5 g/ft³ higher platinum group metal loading (FIG. 7). The change in maximum NO oxidation for the degreened versus aged catalyst articles is illustrated in FIG. 8, which demonstrated that Examples 3 and 10 yielded almost unchanged NO₂ make after aging.

### Example 16. CO and Hydrocarbon Light-Off

Catalyzed soot filter articles (Examples 1A-E, 3, and 10) were evaluated for T₅₀ hydrocarbon and carbon monoxide (CO) light-off temperatures after degreening and aging. Examples 3 and 10 displayed only a small increase in hydrocarbons and CO T₅₀ after aging (FIG. 9).

### Example 17. Engine Test Results for Full-Size Catalyzed Soot Filter Articles

catalyzed soot filter articles (catalyst compositions coated on 10.5″ diameter by 10″ long wall-flow substrates) were prepared and evaluated under engine test conditions. The full-sized Example 1 catalyzed soot filter article was prepared according to Example 1 at a Pt loading of 1.7 g/ft³. The full-size Examples 3 and 10 catalyzed soot filter articles were prepared according to Examples 3 and 10 at a Pt loading of 1.7 and 2.2 g/ft³, respectively. The change in NO oxidation performance for the degreened and aged samples over 6 engine test cycles is provided in FIG. 10, which illustrates that the full-size Example catalyzed soot filler article had the best performance, followed by the full-size Example 3 catalyzed soot filter article and finally, the full-size Example 1 catalyzed soot filter article.

1. An oxidation catalyst composition, the composition comprising a plurality of platinum group metal particles having a multi-modal distribution of particle sizes, the plurality of platinum group metal particles comprising:
a first population of platinum group metal particles having a range of particle sizes of from about 0.5 nm to about 3 nm; and
a second population of platinum group metal particles having a range of particle sizes of from about 4 nm to about 15 nm.

2. The oxidation catalyst composition of claim 1, wherein the first population of platinum group metal particles has a particle size distribution characterized by an average particle size of about 1 nm and at least about 80% of the first population of platinum group metal particles have a particle size within about 1 nm of the average particle size.

3. The oxidation catalyst composition of claim 1, wherein the second population of platinum group metal particles has a particle size distribution characterized by an average particle size of about 6 nm and platinum group metal at least about 80% of the second population of platinum group metal particles have a particle size within about 2 nm of the average particle size.

4. The oxidation catalyst composition of any of claim 1, wherein the ratio by weight of the first population of platinum group metal particles to the second population of platinum group metal particles is from about 10:90 to about 90:10.

5. The oxidation catalyst composition of any of claim 1, wherein the plurality of platinum group metal particles has an average particle size of from about 3 to about 12 nm.

6. The oxidation catalyst composition of claim 1, wherein at least about 90% of the platinum group metal of one or more of the first and second populations of platinum group metal particles is in fully reduced form.

7. The oxidation catalyst composition of claim 1, wherein the platinum group metal of one or more of the first and second populations of platinum group metal particles comprises platinum, palladium, ruthenium, rhodium, iridium, or a combination thereof.

8. The oxidation catalyst composition of claim 1, wherein the platinum group metal of one or more of the first and second populations of platinum group metal particles is platinum.

9. The oxidation catalyst composition of claim 1, further comprising at least one refractory metal oxide support.

10. The oxidation catalyst composition of claim 9, wherein the at least one refractory metal oxide support comprises alumina (Al2O3), silica (SiO2), zirconia (ZrO2), titania (TiO2), ceria (CeO2), or combinations thereof.

11. The oxidation catalyst composition of claim 10, wherein the at least one refractory metal oxide support comprises Al₂O₃ doped with 1-10% SiO₂, TiO₂ doped with 1-20% SiO₂, or ZrO₂ doped with 1-30% SiO₂.

12. The oxidation catalyst composition of claim 9, wherein the first population of platinum group metal particles and the second population of platinum group metal particles are both dispersed on the same refractory metal oxide support.

13. The oxidation catalyst composition of claim 9, wherein the first population of platinum group metal particles and the second population of platinum group metal particles are each dispersed on separate refractory metal oxide supports, wherein the first population of platinum group metal particles is dispersed on a first refractory metal oxide support, and the second population of platinum group metal particles is dispersed on a second refractory metal oxide support, wherein the first refractory metal oxide support and the second refractory metal oxide support are each independently selected.

14. The oxidation catalyst composition of claim 13, wherein the first refractory metal oxide support and the second refractory metal oxide support both comprise the same refractory metal oxide support material.

15. The oxidation catalyst composition of claim 14, wherein the refractory metal oxide support material comprises TiO₂ or SiO₂-doped TiO₂.

16. An oxidation catalyst article comprising a substrate having an inlet end and an outlet end defining an overall length, and a catalytic coating comprising the oxidation catalyst composition of claim 1 disposed on at least a portion thereof.

17. The oxidation catalyst article of claim 16, wherein the substrate is a flow-through monolith or a wall-flow filter.

18. The oxidation catalyst article of claim 16, wherein the oxidation catalyst article is a diesel oxidation catalyst article or a catalyzed soot filter article.

19. The diesel oxidation catalyst article of claim 18, wherein the plurality of platinum group metal particles are disposed on the substrate at a loading of from about 5 g/ft³ to about 200 g/ft³.

20. The catalyzed soot filter article of claim 18, wherein the plurality of platinum group metal particles are disposed on the substrate at a loading of from about 0.5 g/ft³ to about 30 g/ft³.

21. (canceled)

22. (canceled)

23. (canceled)

24. An exhaust gas treatment system comprising the oxidation catalyst article of claim 16, wherein the oxidation catalyst article is downstream of and in fluid communication with an internal combustion engine.

25. (canceled)

26. A method for treating an exhaust gas stream comprising hydrocarbons, carbon monoxide, and/or NOₓ, the method comprising passing the exhaust gas stream through the catalytic article of claim 16.
